(19) United States
(12) Patent Application Publication
(10) Pub. No.: US 2024/0100778 A1
(43) Pub. Date: Mar. 28, 2024

(54) CONTROL SYSTEMS AND METHODS TO MINIMIZE OR ELIMINATE BUILD PLATE DEFLECTION RELATIVE TO A RESERVOIR BASE DURING VAT POLYMERIZATION ADDITIVE MANUFACTURING

(71) Applicant: 3DFortify Inc., Boston, MA (US)

(72) Inventors: Scott GOODRICH, Malden, MA (US); Michael SANTORELLA, Walpole, MA (US); Alex QUINN, Somerville, MA (US); Andrew J. CAUNTER, Somerville, MA (US)

(21) Appl. No.: 18/018,386

(22) PCT Filed: Jun. 20, 2022
(86) PCT No.: PCT/US22/34200

§ 371 Date: Jan. 27, 2023

Related U.S. Application Data
(60) Provisional application No. 63/212,450, filed on Jun. 18, 2021.
(60) Provisional application No. 63/295,390, filed on Dec. 30, 2021.

(51) Int. Cl. B29C 64/393; B29C 64/124; B29C 64/232; B29C 64/245; B33Y 10/00; B33Y 30/00; B33Y 50/02

(52) U.S. Cl. CPC B29C 64/393; B29C 64/124; B29C 64/232; B29C 64/245; B33Y 10/00; B33Y 30/00; B33Y 50/02

(57) ABSTRACT

Control systems and methods for efficiently and effectively achieving and/or maintaining a parallel configuration between a build plate and a printing release surface of an additive manufacturing printer are provided. The methods include actions of over-plunging a drive point into a printing release surface and then calculating the build plate position until it achieves a desired target position. Other methods focus on a homing process for setting a zero position of the build plate. Structures used to help prevent build plate deflection include various armatures having a pinned configuration that help to stabilize a location of the build plate to maintain a substantially parallel configuration with respect to the printing release surface.

### CROSS-REFERENCE TO RELATED APPLICATIONS

This application claims the benefit of each of U.S. Provisional Patent Application Ser. No. 63/212,450, filed on Jun. 18, 2021, and U.S. Provisional Patent Application Ser. No. 63/295,390, filed on Dec. 30, 2021, both entitled “Devices and Methods to Minimize or Eliminate Build Plate Deflection Relative to a Platform During Three-Dimensional Printing,” the entire content of each which is hereby incorporated by reference in each's entirety.

### FIELD

The present disclosure is directed to three-dimensional printing systems, devices, and methods, and more particularly relates to control systems and methods to keep a face of a build plate substantially parallel to an opposed face of a transparent base (e.g., glass) during digital light processing three-dimensional printing.

### BACKGROUND

Additive manufacturing, which can be referred to as three-dimensional printing, can be used to fabricate complex three-dimensional structures using materials such as polymers, metals, ceramics, and composites. Material is added to build a part layer-by-layer using a variety of additive manufacturing processes. Non-limiting examples of additive manufacturing processes include stereolithography (SLA), masked stereolithography (MSLA), selective laser sintering (SLS), fused deposition modeling (FDM), digital light processing (DLP), multi jet fusion (MJF), material jetting (MJ), binder jetting, direct metal laser sintering (DMLS), selective laser melting (SLM), drop on demand (DOD), polyjet, and electron beam melting (EBM). A subset of these processes are sometimes categorized as vat polymerization printing techniques. Vat polymerization entails using a light source to selectively cure a photopolymer resin disposed in a vat or other container. Light from the light source is controlled to cure or otherwise harden the resin, often in a layer-by-layer manner, to form the desired object. Some non-limiting examples of vat polymerization techniques include SLA, DLP, and MSLA.

DLP includes at least two different ways by which the three-dimensional object can be rendered. In one such technique, sometimes referred to as a bottom-up printing technique, a build plate is advanced vertically upwards, away from a vat that includes the printing resin. Each layer of resin is cured by light, such as by a light source disposed below the vat, with the light being able to cure the thin layer closest to the build plate without curing the remaining resin in the vat. As the build plate is advanced further away from the vat, additional layers are cured, the layers being coupled to previously hardened layers, the previously hardened layers being disposed further away from the vat than when they were cured. The printed layers can include support structures that are printed as part of the layers to help support the object with respect to the build plate. When the print job concludes, the object is typically disposed in an upside-down configuration. The object can then be separated from the build plate and/or any support structures that are not intended to be part of the printed object can be removed.

In another DLP technique, sometimes referred to as a top-down printing technique, a build plate is advanced vertically downwards, further into a vat that includes the printing resin. Each layer of resin is cured by light, such as by a light source disposed above the vat that includes the printing resin, with the light being able to cure the thin layer at the top of the vat without curing the remaining resin in the vat. As the build plate is advanced further into the vat, additional layers are cured, the layers being coupled to previously hardened layers, the previously hardened layers remaining in the vat, just further away from the top of the vat. Unlike bottom-up printing, support structures are not as prevalent because the base of the object being printed is supported by the build plate. When the print job concludes, the object is typically disposed in a right side up configuration. The build plate can be removed from the resin and the object separated from the build plate. Between the two techniques, bottom-up printing is currently a more common approach at least because it usually requires a smaller printer, uses less resin, and is more cost-effective because it is the more prevalent technique.

In the process of bottom-up DLP printing, the previous layer of the part being printed is typically positioned at a target layer thickness above a transparent release film and/or glass disposed or otherwise forming a bottom of the vat. These layers are typically approximately in the range of about 50 microns to about 200 microns thick. Fluid is typically pushed out of the gap between the two surfaces to plunge the part to the correct position. The fluid resists this flow by creating a pressure upwards against the previous layer of the part being printed, and downwards against the transparent release film and glass. The force created by this pressure can be defined by the following equation:

$$F = - \frac{3 η {π}^{2} {R}^{4}}{2 {H}^{3}} \frac{dH}{dt}$$

where H is a distance between two parallel circular disks of radius R, η is the viscosity of a Newtonian fluid, t represents a time, and dH/dt represents a rate of change of separation or a speed of the previous layer approaching the release film. This equation is described in the laws governing “Stefan adhesion,” which a person skilled in the art will understand. The equation is sometimes referred to herein as “Stefan's equation.”

The force created by the system may be related to its spring constant, which can be based on the following spring deflection equation:

F=K(H−L)

where K is the spring constant of the system, H is the height of the previous layer above a release film, and L is the target layer height. In at least some cases, K may be a function of the force F. These two equations can be related to each other as follows:

$$F = K ( H - L ) = - \frac{3 η {π}^{2} {R}^{4}}{2 {H}^{3}} \frac{dH}{dt}$$

To print large cross sections out of viscous materials at thin layer heights, a bottom-up DLP printer is typically capable of generating large amounts of force while maintaining the build plate substantially parallel to the glass. For example, a part that is twice as viscous will typically require twice the force to plunge. A cylinder cross section that is twice the radius will typically require sixteen (16) times the force to plunge. These factors are particularly important to account for when attempting to print the most viscous materials in conjunction with printing parts that have some of the largest cross-sections on the market.

If there is any force on the build plate during curing of resin, the fluid between the part and the glass is moving by definition. If resin is cured while it is moving, mechanical properties like strength and surface finish are typically impacted in a negative manner. If a fiber-filled resin is cured while it is moving, the shear forces on fibers can dominate magnetic alignment forces. It is typically difficult, or ultimately not possible, to align fibers in printed parts while the fluid is moving significantly. Therefore it can be important to achieve a near-zero “load at cure” on the build plate. I can also be important to achieve a near-zero rate of change of the build plate load at cure.

Achieving near-zero load at cure can be a major challenge with large parts printed out of viscous materials, even with a very stiff system. To do so, the position of the build plate should typically be controlled within a couple of microns. It is typically not feasible to measure this position directly to that accuracy throughout the course of a print. Instead, the theoretical position of the build plate relative to the glass can be calculated based, at least in part, off a measured load on the build plate, a measured position of a Z arm of the printer that supports the build plate, and calibration data that relates those two measurements to the build plate position. By controlling this theoretical build plate position instead of the measured position, deflection caused by plunge forces can be compensated for and the target layer height can be determined quickly and accurately, independent of the viscosity of the material and the geometry of the part.

Achieving near-zero load at cure is further exacerbated when printing with a high viscosity resin. A high viscosity resin can have a viscosity value of 200 centipoise or higher. While there theoretically is no cap on how high a value of viscosity can be achieved by a fluid (e.g., resin), to the extent a range of high viscosity needs to be bound, a high viscosity resin can have a viscosity value approximately in the range of about 200 centipoise to about 250,000 centipoise. The high viscosity resin is driven out from underneath the build plate or printed part and deflects the build plate out of a preferred configuration in which the build plate is substantially parallel to a base of a printing reservoir. In print jobs that utilize resin that is not highly viscous, typically the deflected build plate is able to settle back into its preferred, substantially parallel configuration because it can be bias back into position by pushing through the resin without much resistance. However, in print jobs that utilize highly viscous resin, the build plate cannot naturally deflect back into place because the highly viscous resin does not displace as easily to allow the build plate to naturally return to its biases, substantially parallel configuration. Instead the deflected build plate can remain stuck in a deflected configuration with significant force applied by the pressure of the viscous resin onto the printed part and build plate. Accordingly, additive manufacturing printers, and methods of performing additive manufacturing, that do not utilize high viscosity resin do not contemplate solutions for minimizing build plate deflection. It is not an issue because the deflected build plate in such printing operations typically resolves itself into a non-deflected state. Instead, current additive manufacturing printers and printing techniques focus on achieving a target layer height to set the build plate position for printing.

From Stefan's equation, the conclusion can be drawn that the speed of the build plate may have an optimal value that is a function of the height of the last layer printed above the printing glass. A mathematically-derived control of plunge speed can be used to maximize print speed while preventing damage to the part that is being printed.

Competitors in the DLP industry are generally not forthcoming about how they solve a plunge force challenge. For example, to date it does not appear there is any advertising of competitors formulating a high mechanical stiffness of a system, or closed-loop control of a build plate position.

Accordingly, there is a need for systems designed to minimize or even eliminate build plate deflection.

### SUMMARY

The present disclosure provides for mechanical designs to achieve a high spring constant, or system stiffness, between the build plate and glass base of a vat polymerization process. The designs provided create approximately in the range of about 10 pounds of force for every 1 μm of deflection to about 20 pounds of force for every 1 μm of deflection between the build plate and glass base.

The present disclosure also includes control schemes to drive the theoretical position of the part being printed to the target layer height while achieving low load. 3D printers typically control a measured position of the driving lead screw, or the driven components at the Z axis. These measured positions do not accurately describe the actual position of the part being printed relative to the glass base at least because the printed part can be deflecting away from the glass base due, at least in part, to the forces of the printing process. By calibrating the spring behavior of the system, deflection from printing forces can be accounted for and the target layer height can be reached quickly and accurately, independent of the viscosity of the material and the geometry of the part.

At least some of the techniques provided for herein focus on commanding a build plate to be plunged downwards beyond, i.e., below, a target position for the build plate, into a print reservoir having a high viscosity resin disposed in it, then lifting the build plate upwards to place the build plate in a substantially parallel configuration with respect to a base of a printer reservoir at the target position for the build plate. By over-plunging and then moving the build plate back up to the target position, it minimizes or fully negates the deflection caused by the high viscosity resin.

The present disclosure is implemented, at least in part, by utilizing certain aspects of Stefan's equation to affect the mechanical behavior of a 3D printer.

One embodiment of an additive manufacturing apparatus includes a printing release surface, a drive point, a build plate, a driver, and a processor. The printing release surface is configured to have resin to be printed disposed on it. The drive point is configured to move away from the printing release surface while producing an object using the additive manufacturing apparatus. The build plate has a main surface that is substantially opposed to the printing release surface. Further, the build plate is configured to move directionally with the drive point. The driver is configured to move the build plate with respect to the printing release surface. The processor is configured to command the driver to move the drive point towards the printing release surface to an over-plunged position. The over-plunged position is closer to the printing release surface than a target layer position is to the printing release surface. The processor is also configured to command the driver to move the drive point away from the printing release surface, towards the target layer position, as well as command the driver to stop the drive point when it reaches the target layer position.

The printing release surface can be configured to have a high viscosity resin disposed on it. The processor being configured to command the driver to move the drive point towards the printing release surface to an over-plunged position can thus include the processor being configured to command the driver to move the drive point, as well as the build plate, into a high viscosity resin. The high viscosity resin can have a viscosity value approximately in the range of about 200 centipoise to about 250,000 centipoise, although a person skilled in the art will appreciate that even higher values are possible.

The processor of the apparatus can further be configured to calculate a target speed of the build plate to move towards the printing release surface. The target speed can be based on a calculated height of the build plate and at least one of: a viscosity of resin used to produce the object, a maximum pressure that can be sustained by the resin used to produce the object, a maximum force that can be sustained by the object, and/or geometric information about the object being produced. Further, the processor can be configured to determine if the target build plate position has been achieved. When the target build plate has not been achieved, the processor can be configured to measure and/or calculate a build plate height, while when the target built plate position has been achieved, the processor can be configured to maintain the target build plate position.

The additive manufacturing apparatus can include additional components or features. For example, the additive manufacturing apparatus can include a housing, a vertical rail, a build plate arm, and a first linear guide. The vertical rail can be disposed in the housing. The build plate arm can be coupled to the build plate to couple the build plate to the vertical rail. The first linear guide can be disposed on the vertical rail and can be configured to couple the build plate arm to the vertical rail. Further, the first linear arm can be configured to move along the vertical rail to adjust a location of the build plate, with the first linear guide also being configured to communicate to the processor a measured position.

Still further, the additive manufacturing apparatus can include a pusher arm, a second linear guide, and a connector. The pusher arm can extend distally at an angle with respect to the vertical rail. The pusher arm can have a first end disposed more proximate to the vertical rail and a second end that extends further away from the vertical rail than the first end. The second linear guide can be disposed on the vertical rail, and further, can be configured to couple the pusher arm to the vertical rail. Additionally, the second linear guide can be configured to move along the vertical rail to adjust a location of the build plate in conjunction with the first linear guide such that a driving force applied to at least one of the first and second linear guides is configured to be at least partially transferred to the other of the first and second linear guides. The connector can couple the second end of the pusher arm to the build plate arm. The connector can be, for example, a pin-in-slot connector. In some embodiments, the connector can be disposed along a longitudinal axis that extends through an approximate center of the build plate, with the longitudinal axis being substantially normal to the printing release surface. In some other embodiments, the connector can be disposed away from a longitudinal axis that extends through an approximate center of the build plate, further from the vertical rail than the longitudinal axis is from the vertical rail, with again the longitudinal axis being substantially normal to the printing release surface. In some embodiments, the additive manufacturing apparatus can include a load cell coupled to the pusher arm. The load cell can be configured to measure a load on the build plate.

The additive manufacturing apparatus can also include one or more force-applying components coupled to at least one of the first or second linear guides to apply a force to such guide(s) to move at least one of the first or second linear guides along the vertical rail. The force-applying component(s) can include at least one of: (a) a lead screw and lead nut; (b) a stepper motor; and/or (c) the driver. In some embodiments the additive manufacturing apparatus can include a compression component. The compression component can be in communication with the build plate such that the compression component is configured to translate a compressive force imparted on the compression component to the build plate to allow the build plate to be aligned in a more parallel manner with respect to the printing release surface. The compression component can include a spring array.

In some embodiments the apparatus can include a linear encoder coupled to the build plate arm. The linear encoder can be configured to measure a position of the build plate. The printing release surface can be transparent. For example, the printing release surface can include glass. Further, the printing release surface can be part of a print reservoir of the additive manufacturing apparatus, with the printing release surface serving as a base of the reservoir.

A reaction load result from a load applied to the build plate and a reaction load applied in the substantially opposite direction by the pusher arm on the build plate can be disposed a substantially equal distance away from the first linear guide such that a moment enacted about the first linear guide is substantially zero.

The additive manufacturing apparatus can also include a controller. The controller can be configured, for example, to calculate one or more positions of the build plate. For example, the controller can be configured to calculate positions of the build plate based on at least one of one or more measured loads, one or more measured positions of at least one of the drive point or the build plate arm, and/or calibration data associated with the additive manufacturing apparatus. Further, the controller can be configured to control at least one of a theoretical position of the build plate or a velocity of the build plate.

A method of additive manufacturing includes commanding a driver to move a drive position towards a printing release surface having resin disposed on it such that the build plate comes in contact with the resin. The driver commands the drive point to try and move to an over-plunged position in which the drive point would be located at a position that is closer to the printing release surface than a designated target layer position is to the printing release surface. The method further includes commanding a driver to move the drive point away from the printing release surface, towards the designated target layer position. Still further, the method includes commanding the driver to stop the drive point at the designated target layer position, with a main surface of the build plate being substantially parallel to the printing release surface. The drive position controls a position of the build plate.

The resin can be a high viscosity resin, which can have a viscosity value approximately in the range of about 200 centipoise to about 250,000 centipoise, although a person skilled in the art will appreciate that even higher values are possible.

The method can further include actions such as, prior to commanding the drive point to move away from the printing release surface, measuring at least two of a measured load being imparted on the build plate, a measured position of the drive point, or a measured component coupled to the build plate, calculating a current build plate position based on at least two of the measured load being imparted on the build plate, the measured position of the drive point, or a measured component coupled to the build plate, and determining if the current build plate position is at a designated target layer position. If the current build plate position is at the designated target layer position, waiting for the load being imparted on the build plate to reach or decrease below a target load threshold, and after it does, beginning a printing process. If the current build plate position is not at the designated target layer position, commanding the build plate to move towards the printing release surface and continuing the measuring, calculating, and determining actions until the current build plate position is at the designated target layer position. In some such embodiments, the action of beginning a printing process can include exposing a layer of resin to at least one of a radiation source or a light source to cure the resin. Upon completion of the printing process, the method can also include executing a peel process to remove a printed part from the build plate. The action of calculating a current build plate position can be performed based on calibration data.

The method can also include actions such as, after calculating a current build plate position, calculating at least one of a current build plate speed or a target build plate speed, and adjusting a speed of the build plate in view of the calculated current build plate speed and/or target build plate speed. Adjusting a speed of the build plate can include, for example, adjusting a speed of a motor that operates the build plate.

The method can also include actions such as commanding a drive point to move towards the printing release surface in conjunction with a homing process, measuring a load being imparted on the build plate, and determining if the measured load meets or exceeds a target homing load value. If the measured load meets or exceeds the target homing load value, the method can include setting the current position of the build plate as zero. However, if the measured load does not meet or exceed the target homing load value, the method can include commanding the drive point to move towards the printing release surface and continuing the respective measuring and determining actions until the measured load meets or exceeds the target homing load value.

In some embodiments the method can include calculating a target speed or a target position of the build plate relative to the printing release surface based on a calculated height of the build plate and at least one of: a viscosity of the resin disposed on the printing release surface, a maximum pressure that can be sustained by the resin disposed on the printing release surface, a maximum force that can be sustained by the resin disposed on the printing release surface, and/or geometric information about an object to be printed by the additive manufacturing method. The method can further include determining if the designated target build plate position has been achieved. If the designated target build plate position has not been achieved, the method can further include at least one of measuring or calculating a build plate height. However, if the designated target build plate position has been achieved, the method can further include maintaining the designated target build plate position. The method can also include exposing at least a portion of the resin to an ultraviolet image.

The action of commanding a build plate to move towards a printing release surface having resin disposed on it can include moving a gantry to a first position along a Z-print axis, with the first position being disposed below a target layer height, subsequently moving the gantry to a second position along the Z-print axis, with the second position being disposed above the first position and representative of a target layer height of an object being manufactured, and curing a layer of the resin while the build plate is disposed at the second position.

Another embodiment of an additive manufacturing apparatus includes a housing, a vertical rail disposed in the housing, a pusher arm, a build plate, a printing release surface, a build plate arm, a connector, and a first linear guide. The pusher arm extends distally at an angle with respect to the vertical rail, and has a first end disposed more proximate to the vertical rail and a second end extending further away from the vertical rail than the first end. The build plate has a substantially flat main surface, while the printing release surface is substantially opposed to the main surface of the build plate. The build plate arm is coupled to the build plate and couples the build plate to the vertical rail. The connector couples the second end of the pusher arm to the build plate arm, and the first linear guide is disposed on the vertical rail. The first linear guide is configured to couple the build plate arm to the vertical rail.

In at least some embodiments the apparatus can include a second linear guide, which can also be disposed on the vertical rail. The second linear guide can be configured to couple the pusher arm to the vertical rail, and it can also be configured to move along the vertical rail to adjust a location of the build plate in conjunction with the first linear guide such that a driving force applied to at least one of the first and second linear guides is configured to be at least partially transferred to the other of the first and second linear guides. The apparatus can also include a force-applying component that can be coupled to the pusher guide. The force-applying component can be configured to apply the driving force to the pusher guide. The force-applying component can be, for example, at least one of (a) a lead screw and lead nut; (b) a stepper motor; or (c) a driver.

The connector can be, for example, a pin-in-slot connector. In some embodiments, the connector can be disposed along a longitudinal axis that extends through an approximate center of the build plate, with the longitudinal axis being substantially normal to the printing release surface. In some other embodiments, the connector can be disposed away from a longitudinal axis that extends through an approximate center of the build plate, further from the vertical rail than the longitudinal axis is from the vertical rail, with the longitudinal axis again being substantially normal to the printing release surface.

The printing release surface can be transparent. For example, the printing release surface can include glass. Further, the printing release surface can be part of a print reservoir of the additive manufacturing apparatus, with the printing release surface serving as a base of the reservoir.

A reaction load that can result from a load applied to the build plate and a reaction load applied in the substantially opposite direction by the pusher arm on the build plate can be disposed a substantially equal distance away from the first linear guide such that a moment enacted about the first linear guide can be substantially zero.

In at least some embodiments, the apparatus can include a load cell coupled to the pusher arm. The load cell can be configured to measure a load on the build plate. In at least some embodiments, the apparatus can include a linear encoder coupled to the build plate arm and configured to measure a position of the build plate.

The apparatus can include a release film. The release film can be disposed between the build plate and the printing release surface. The apparatus can include a compression component. The compression component can be in communication with the build plate such that the compression component can be configured to translate a compressive force imparted on the compression component to the build plate to allow the build plate to be aligned in a more parallel manner with respect to the printing release surface. The compression component can be, for example, a spring array.

In at least some embodiments the apparatus can include a controller. The controller can be configured, for example, to calculate one or more positions of the build plate. For example, the controller can be configured to calculate positions of the build plate based on at least one of one or more measured loads, one or more determined positions of at least one of the build plate or the build plate arm, and/or calibration data associated with the additive manufacturing apparatus. Further, the controller can be configured to control at least one of a theoretical position of the build plate or a velocity of the build plate.

The printing release surface can be configured to have a high viscosity respond disposed on it. The high viscosity resin can have a viscosity value approximately in the range of about 200 centipoise to about 250,000 centipoise, although a person skilled in the art will appreciate that even higher values are possible.

The additive manufacturing apparatus can include a driver that can be in mechanical communication with the pusher arm such that it is configured to move the build plate with respect to the printing release surface via the pusher arm. In some such embodiments, the processor can be configured to command the driver to move the drive point towards the printing release surface to an over-plunged position, with the over-plunged position being closer to the printing release surface than a target layer position is to the printing release surface. The processor can further be configured to command the driver to move the drive point away from the printing release surface, towards the target layer position, as well as command the driver to stop the drive point when it reaches the target layer position.

In some such embodiments, the processor can be further configured to calculate a target speed of the build plate to move towards the printing release surface. This can be based, for example, on a height of the build plate and at least one of: a viscosity of resin used to produce an object being manufactured, a maximum pressure that can be sustained by the resin used to produce the object being manufactured, a maximum force that can be sustained by the resin used to produce the object being manufactured, and/or geometric information about the object being manufactured. The processor can also be configured to determine if the target build plate position has been achieved. When the target build plate position has not been achieved, the processor can be further configured to at least one of measure or calculate a build plate height, while when the target build plate position has been achieved, the processor can be further configured to maintain the target build plate position.

### BRIEF DESCRIPTION OF THE DRAWINGS

This disclosure will be more fully understood from the following detailed description, taken in conjunction with the accompanying drawings, in which:

FIG. 1A is a perspective view of one embodiment of a printing apparatus;

FIG. 1B is a side view of the printing apparatus of FIG. 1A having a side panel of a housing removed to illustrate components of the printing apparatus disposed within the housing;

FIG. 2A is a perspective front view of another embodiment of a printing apparatus, the view illustrating only a top portion of the printing apparatus;

FIG. 2B is a perspective back view of the printing apparatus of FIG. 2A;

FIG. 2C is a side view of the printing apparatus of FIG. 2A;

FIG. 3A is one embodiment of a portion of a printing process;

FIG. 3B is another embodiment of a portion of a printing process;

FIG. 4 is one embodiment of another portion of a printing process;

FIG. 5A is a schematic side view of yet another embodiment of a printing apparatus, the printing apparatus having two guides, being operated with a hemispherical test fixture, and being in an unloaded configuration;

FIG. 5B is a schematic side view of the printing apparatus of FIG. 5A, the printing apparatus being in a loaded configuration such that a build plate of the printing apparatus imparts a force in an upwards Z-direction on the hemispherical text fixture;

FIG. 6A is a schematic side view of another embodiment of a printing apparatus, the printing apparatus having one guide, being operated with a hemispherical text fixture, and being in an unloaded configuration;

FIG. 6B is a schematic side view of the printing apparatus of FIG. 6A, the printing apparatus being in a loaded configuration such that a build plate of the printing apparatus imparts a force in an upwards Z-direction on the hemispherical text fixture;

FIG. 7 is one embodiment of yet another portion of a printing process;

FIG. 8 is one embodiment of a Z-position control process;

FIG. 9 is a front cross-sectional view of an embodiment of a portion of a printing apparatus similar to the printing apparatus of FIG. 2A, the portion being directed to a leveling and homing system for the printing apparatus.

FIG. 10A is a schematic side view of one embodiment of a portion of a printing apparatus of the prior art;

FIG. 10B is a schematic side view of one embodiment of a portion of a printing apparatus similar to the printing apparatus of FIG. 2A, illustrating a build plate under load not being parallel to a glass base of a print reservoir of the printing apparatus;

FIG. 10C is a schematic side view of another embodiment of a portion of a printing apparatus similar to the printing apparatus of FIG. 10B, but having some changes to the configuration that aid in a build plate of the printing apparatus under load being maintained substantially parallel to a glass base of a print reservoir of the printing apparatus;

FIG. 11 is a schematic side view of another exemplary embodiment of a portion of a printing apparatus in accordance with the present disclosures, this apparatus including a two tower Z-axis design; and

FIG. 12 is a schematic representation of a computer system upon which the processes and control schemes described herein can be performed.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

To the extent features, sides, objects, arms, beams, sensors, steps, or the like are described as being “first,” “second,” “third,” etc., such numerical ordering is generally arbitrary, and thus such numbering can be interchangeable. Still further, in the present disclosure, like-numbered components and/or like-named components of various embodiments generally have similar features when those components are of a similar nature and/or serve a similar purpose, unless otherwise noted or otherwise understood by a person skilled in the art. To the extent the present disclosure includes prototypes, mock-ups, schematic illustrations, bench models, or the like, a person skilled in the art will recognize how to rely upon the present disclosure to integrate the techniques, systems, devices, and methods into a product, such as a 3D printing apparatus. The present disclosure may use or describe particular components using interchangeable or related terms. Moreover, it will be appreciated that although features may be discussed with respect to one embodiment within the present disclosure, these features can be applied to every embodiment of the present disclosure where such feature would be supported.

Vat Polymerization Printing Apparatus

The disclosures contained in the present application can be carried out on a variety of different types of 3D printers (or additive manufacturing printers), including but not limited to printers that utilize digital light processing (DLP). Because a person skilled in the art will generally understand how DLP additive manufacturing works, the present disclosure does not provide all details related to the same. A person skilled in the art will understand how to apply the principles, techniques, and the like disclosed herein to DLP processes and DLP printers. Some non-limiting examples of DLP printers and techniques with which the present disclosure can be used include those provided for in U.S. Pat. No. 10,703,052, entitled “Additive Manufacturing of Discontinuous Fiber Composites Using Magnetic Fields,” U.S. Pat. No. 10,732,521, entitled “Systems and Methods for Alignment of Anisotropic Inclusions in Additive Manufacturing Processes,” and the FLUX 3D printer series, including the FLUX ONE 3D printer, manufactured by 3DFortify Inc. of Boston, MA (further details provided for at http://3dfortify.com/ and related web pages), the contents of all being incorporated by reference herein in their entireties.

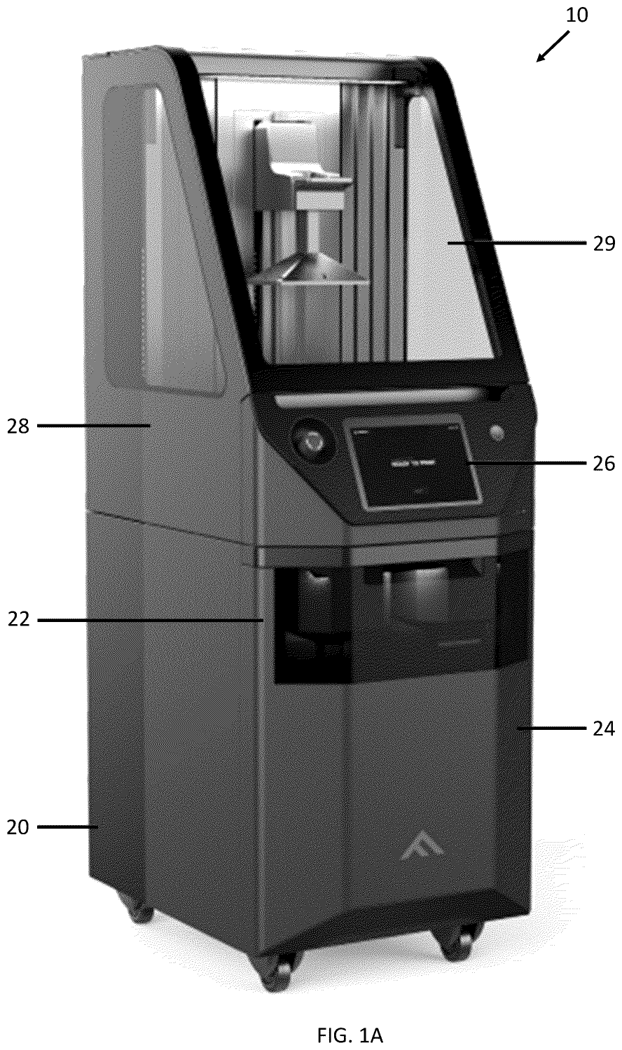

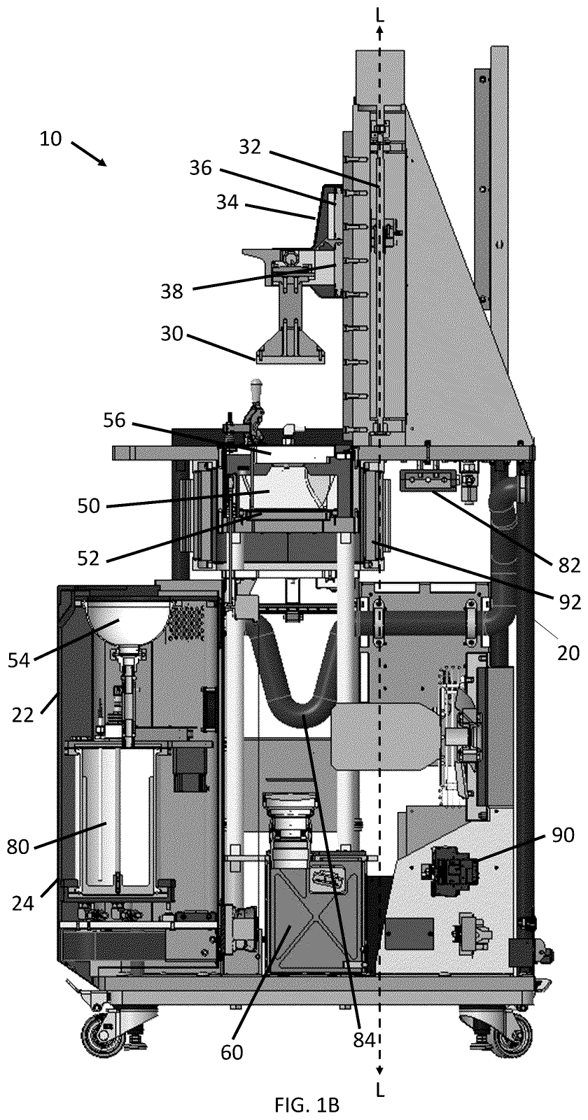

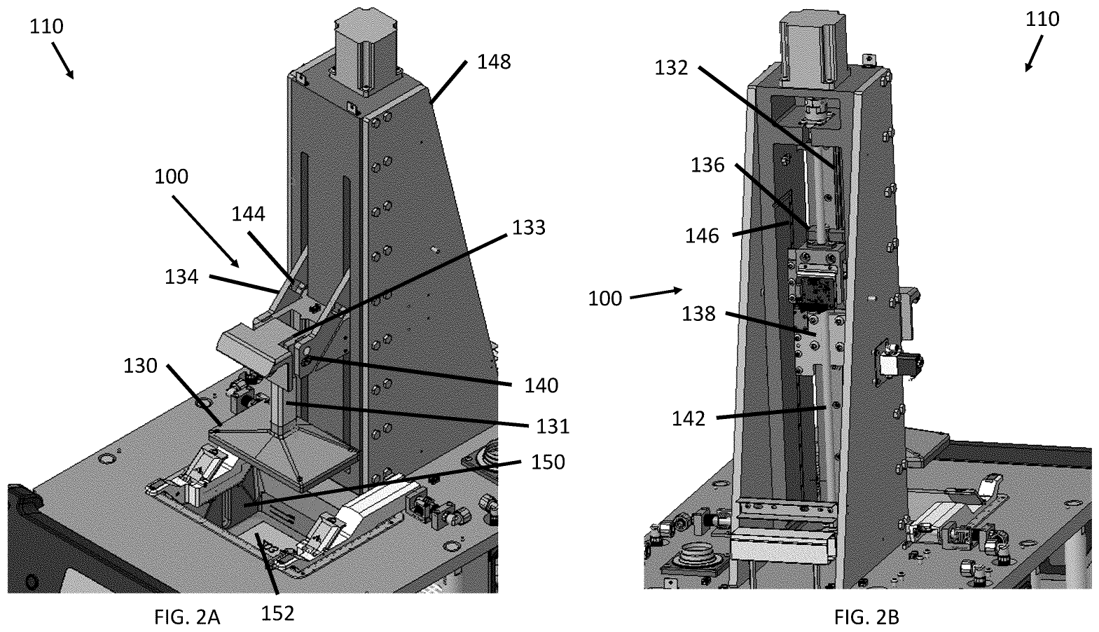

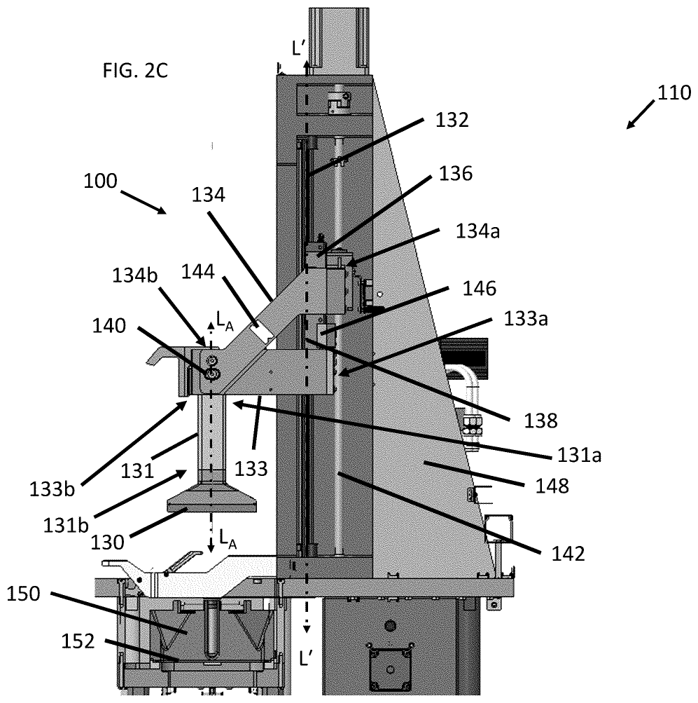

FIGS. 1A and 1B illustrate one exemplary embodiment of a FLUX ONE 3D printer 10. The printer 10 includes an outer casing or housing 20 in which various components of the printer 10 are disposed. The FLUX ONE 3D printer is designed to use a bottom-up printing technique, and thus includes a build plate 30 that can be advanced vertically, substantially parallel to a longitudinal axis L of the printer 10 such that the build plate 30 can be moved vertically away from a print reservoir 50 in which resin to be cured to form a desired part is disposed. Features for moving the build plate 30 are described in greater detail with respect to an alternative embodiment of a printer 110 provided for in FIGS. 2A-2C, but generally the build plate 30 can be advanced up and down with respect to a linear rail 32 as desired, the linear rail 32 being substantially colinear with the longitudinal axis L. As a result, the rail 32 can be considered a vertical rail. The build plate 30 can be associated with the linear rail 32 by way or one or more coupling components, such as arm or armatures 34, guides 36, 38, and/or other structures known to those skilled in the art for creating mechanical links that allow one component to move with respect to another.

As described herein, as the build plate 30 moves away from the print reservoir 50, the resin is cured to the build plate 30 and/or to already cured resin to form the printed part in a layer-by-layer manner as the build plate 30 advances away from the reservoir 50. The resin is cured, for example, by a light source and/or a radiation source, as shown a digital light projector 60. The reservoir 50 can include a glass base 52 to allow the digital light projector 60 to pass light into the reservoir 50 to cure the resin. The glass base 52 can more generally be a transparent platform through which light and/or radiation can pass to selective cure the resin. Resin can be introduced to the printer 10 by way of a materials dock 54 that can be accessible, for example via a drawer 22, formed as part of the housing 20.

One or more mixers can be included to help keep the resin viscous and homogeneous. More particularly, at least one mixer, as shown an external mixer 80, can be in fluid communication with the print reservoir 50 to allow resin to flow out of the reservoir 50, into the mixer 80 to be mixed, and then flow back into the reservoir 50 after it has been mixed by the mixer 80. The mixer 80 can be accessible, for example, via a front panel door 24 provided as part of the housing 20. At least one heating element 82 can be included for use in conjunction with the mixer 80 such that the treated (i.e., mixed) resin is also heated. In the illustrated embodiment the heating element 82 is disposed proximate to the print reservoir 50, heating the resin after it has been mixed by the mixer 80, although other location are possible, including but not limited to being incorporated with the mixer 80 to heat and mix simultaneously and/or consecutively. The resin can be heated more than once by additional heating elements as well. Resin that travels from the reservoir 50, to the mixer 80, and back to the reservoir 50 can flow through any number of conduits or tubes configured to allow resin to travel therethrough, such as the conduits 84 illustrated in FIG. 1B.

The resin can also flow through a reservoir manifold 56, which can be disposed above the print reservoir 50. The manifold 56 can serve a variety of purposes, including but not limited to helping to maintain the position of the reservoir 50 during operation, and helping to facilitate mechanical, electrical, and fluid connections between the reservoir and other components of the printer 10. For example, the manifold can be designed to allow resin to be mixed and/or heated to flow out of the reservoir 50, as well as allow mixed and/or heated resin to flow into the reservoir 50 via ports formed therein. Electrical connections to help operate various features associated with the reservoir 50, such as monitoring of a level of resin and/or monitoring an orientation of one or more components disposed and/or otherwise situated with respect to the reservoir 50, can be passed through the manifold 56. The electrical connections may be associated with various electronics and the like housed within the printer 10, for example in an electronics panel 90. Additional details about a reservoir manifold are provided for in International Patent Application No. WO 2021/217102, entitled “Manifold and Related Methods for Use with a Reservoir for Additive Manufacturing,” the contents of which is incorporated by reference herein in its entirety.

In some embodiments, a magnetic fiber alignment system 92 can be provided for as part of the printer 10. Such a system 92 can help to control aspects of a print job when magnetic functional additives, such as magnetic particles, are associated with the resin being printed. More specifically, the system 92 can include one or more magnets and/or magnetic field generators that enable the location of the magnetic particle including resin to be controlled by the system 92. Other functional additives that are not necessarily magnetic can also be incorporated with the resin.

A touch screen 26 or other user interface can be included as part of the housing 20 to allow a user to input various parameters for a print job and/or for instructions, signals, warnings, or other information to be passed along by any systems of the printer 10 to a user. Still further, the housing 20 can include an openable and/or removable hood 28 that enables a printed part, as well as components of the printer 10, to be accessed. The hood 28 can also include a viewing portion, such as a window 29, that allows a user to view a print job being performed. As shown, the build plate 30, and thus a part being printed that will be attached to the build plate 30, can be seen through the window 29. Further, the reservoir 50, manifold 56, and other components of the printer 10 can also be visible through the window 29.

Build Plate Drive System

FIGS. 2A-2C illustrate one exemplary embodiment of a build plate drive system 100 of a 3D printer or printing apparatus 110, which is a top portion of the 3D printer 110. The build plate drive system 100 is configured to minimize an amount a build plate 130 of the printer 130 deflects in use. The mechanical solutions implemented in the present disclosure achieve high stiffness with a single-tower system, sometimes referred to herein as a “pusher” arm design. The torsional stiffness (i.e., resistance to angular deflection) of a linear guide can be a primary contributor to system deflection in a single-axis DLP printer drive system. Even large, expensive linear guides cannot prevent all angular deflection due to moment loading.

The pusher arm design of the build plate drive system 100 reduces and/or eliminates deflection from moment loading of a build plate guide 138, which in turn reduces and/or eliminates deflection of the build plate 130. Similar to the printer 10, the printer 110 includes a linear rail 132 that extends substantially vertically along a longitudinal axis L′. The build plate 130 is configured to be coupled to the liner rail 132 and move vertically up and down, substantially parallel to the longitudinal axis L′. The build plate 130 can be coupled to the linear rail 132 by way of one or more arm or armatures. In the illustrated embodiment, a first end 134a of a pusher arm 134 is coupled to the rail 132 and a second end 134b of the pusher arm 134 is coupled to a second end 133b of a horizontal build plate arm 133, sometimes referred to as a first build plate arm or the build plate arm, with a first end 133a of the horizontal build plate arm 133 being coupled to the rail 132. In the illustrated embodiment, the second end 133b of the horizontal build plate arm 133 is coupled to the second end 134b of the pusher arm 134 by way of a pin-in-slot connection or connector 140, which in this illustrated instance is positioned above an approximate center of the build plate 130 and an approximate center, and thus a central longitudinal axis L_{A}, of a vertical build plate arm or stem 131, sometimes referred to as a second build plate arm. In some instances, the vertical build plate arm 131 can be considered a part of the build plate 130 such that reference to a build plate arm is considered to be the horizontal build plate arm 133. The central longitudinal axis L_{A} extends through the approximate center of the build plate 130 and is substantially normal to an upward-facing main surface of the glass base 152. As shown, a first end 131a of the vertical build plate arm 131 can be coupled to the second end 133 of the horizontal build plate arm 133, with a second end 131b of the vertical build plate 131 coupled to the build plate 130, thus allowing movement of the pusher arm 134 with respect to the rail 132 to be translated to movement of the build plate 130 with respect to the rail 132 too. In some instances, the rotator 140 can include a rotary bearing, which can be used, for example, on a contact surface of the pin to the slot, in turn preventing friction at the connection point. Other coupling mechanisms or connectors capable of forming a similar type of connection can be used in lieu of and/or in addition to the pin-in-slot connection 140, including but not limited to a pin inside of a clearance hole.

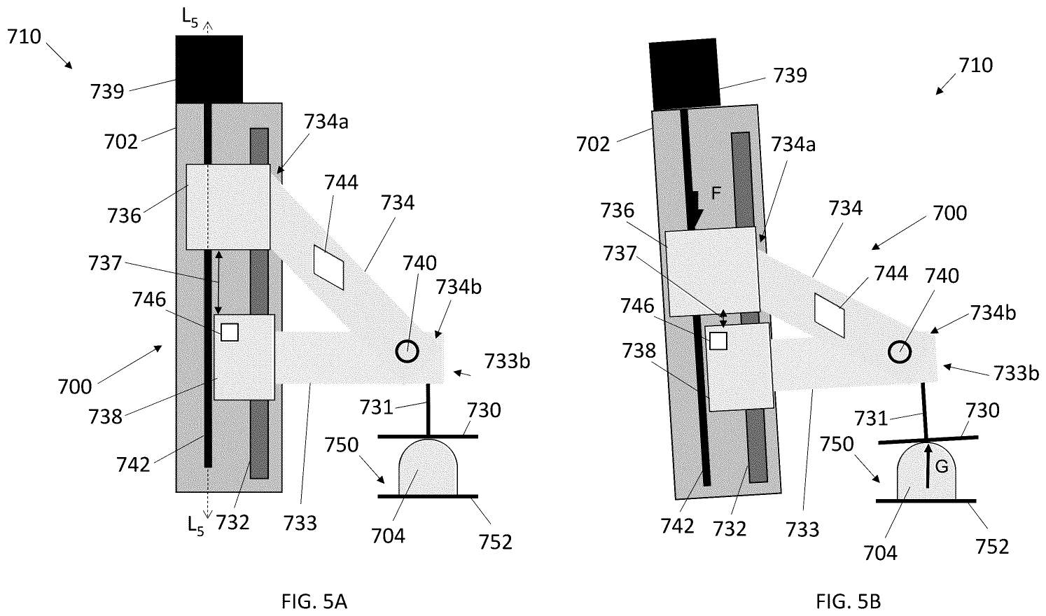

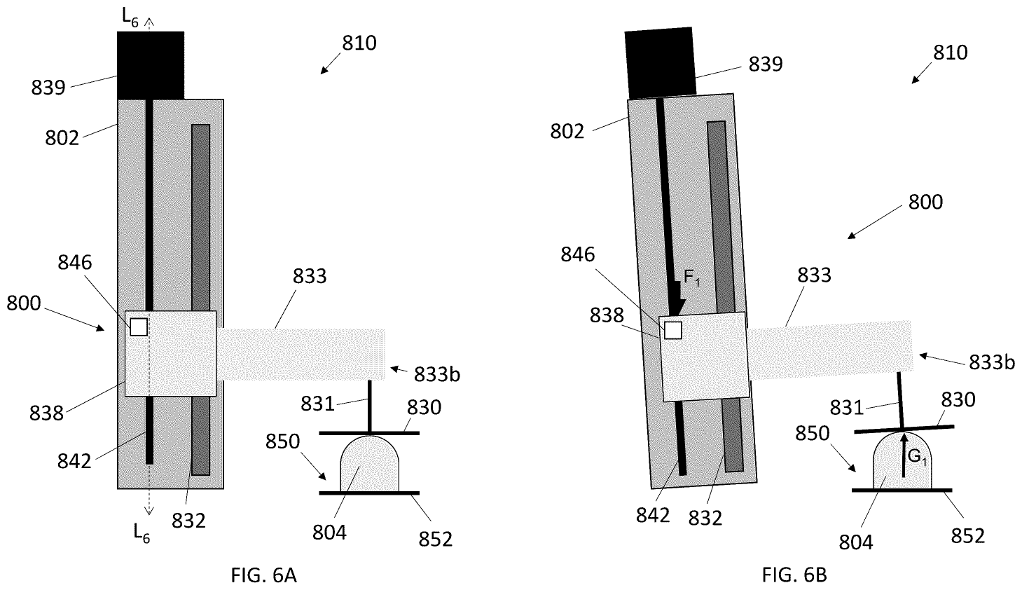

Still further, in the illustrated embodiment two linear guides are included—a build plate linear guide 138, sometimes referred to as a first linear guide, and a pusher linear guide 136, sometimes referred to as a second linear guide. The guides 136, 138 are configured to run on the same linear rail 132, both translating in a Z direction, substantially normal to a glass base 152 of a reservoir 150 (i.e., substantially normal to a plane that extends through an entire surface of the glass base 152). In the illustrated embodiment, the pusher linear guide 136 is shown as an upper guide and the build plate linear guide 138 is shown as a lower guide, though in other embodiments which is upper and which is lower can be reversed. The second linear guide 136 can be driven by a force-applying component, for example, by a lead screw 142, which in turn can push on the respective arm, in this instance the pusher arm 134. A person skilled in the art will appreciate that in at least some instances the lead screw 142 can be used in conjunction with a lead nut. In some instances, driving the lead screw 142 can cause the pusher arm 134 to be driven downwards. The driving force of the lead screw 142 can be transferred to the second linear guide 136. Other force-applying components that can be used in lieu of or in addition to a lead screw and/or lead nut include a belt-driven gantry, a hydraulic piston, and/or a rack-and-pinion system, among other options known to those skilled in the art. By way of non-limiting example, other embodiments provided for herein provide for the use of a stepper motor, for instance to drive a lead screw like the lead screw 142 (see, at least, FIGS. 5A-6B, and related descriptions). The force-applying components can also be considered drivers, with drivers including but not limited to a motor or other similar actuation mechanism known to those skilled in the art that can be configured to move the build plate 130 towards and away from the glass base 152. Such force-applying component, such as a stepper motor (see, e.g., the stepper motors 739 and 839 of FIGS. 5A-6B), can be in mechanical communication with the pusher arm 134 to drive the build plate 130.

Additional features can also be incorporated into the build plate drive system 100. For example, a load cell 144 can be positioned on, or otherwise can be associated with, the pusher arm 134. The load cell 144 can be used, for instance, to measure an amount of load imparted on the build plate 130. By way of further example, a linear encoder 146 can be positioned on, or otherwise can be associated with, the vertical build plate arm 131. The linear encoder 146 can be used to measure linear movement of the vertical build plate arm 131, and thus the build plate 130. A person skilled in the art will appreciate other locations a load cell(s) 144 and a linear encoder(s) 146 can be disposed and other ways such cell(s) and encoder(s) can be configured to measure various parameters of the system 100 and/or the printer 110. Further, a person skilled in the art will appreciate other types of sensors, transducers, and the like that can be incorporated as part of the system 100 and/or the printer 110 without departing from the spirit of the present disclosure. For example, a rotary encoder on the lead screw can be used in lieu of the lead screw. Additionally, position can be measured by counting the number of steps commanded to a stepper motor (i.e., a non-limiting embodiment of a driver configured to move the build plate) that drives the lead screw, among other techniques known to those skilled in the art.

As shown, additional stability for the build plate drive system 100 can be provided by one or more stiffening gussets 148. As shown, two stiffening gussets 148 are opposed to each other, disposed on opposite sides of the rail 132 and lead screw 142, helping to define a Z-tower of the printer 110. The Z-tower can include the gussets 148 and the rail 132, among other features of the system 100. The stiffening gussets 148 can provide additional stability to the system 100, and thus can help reduce and/or eliminate build plate deflection.

When a load is applied to the build plate 130, an equal and opposite load can be applied at the pin-in-slot connection 140 between the pusher arm 134 and the vertical build plate arm 131. Because as designed this reaction load is positioned at approximately the same distance from the build plate linear guide 138 as the load applied to the build plate 130, there is little to no moment enacted about the build plate guide 138. This reduces and/or eliminates all build plate defection caused by the build plate linear guide 138.

Under the same loading condition, the reaction force at the pin-in-slot connection 140 can generate a moment about the pusher linear guide 136. This moment can create angular rotation in the pusher linear guide 136. The pusher linear guide can be free to rotate without causing rotation of the vertical build plate arm 131 at least because they are only coupled by the clearance fit pin-in-slot connection 140. The effect is that little to none of the deflection in the pusher arm 134 is realized in the position of the build plate 130.

With respect to the present disclosure, any of the components, in any combination, can be considered a deflection prevention means: the vertical build plate arm 131, the horizontal build plate arm 133, the pusher arm 134, the pusher arm linear guide 136, the build plate arm linear guide 138, and the connector 140, as well as the equivalent components thereof provided for in other embodiments disclosed herein. By decoupling the moment loading on the Z-tower from the build plate arm, deflection is prevented, and thus any arrangement of parts that allows for this decoupling can be considered a deflection prevention means, whether such configuration is provided for herein, derivable from the present disclosures, and/or otherwise understood to be a suitable configuration by a person skilled in the art in view of the present disclosures. With respect to the present disclosure, by coupling a secondary linear guide (e.g., the pusher arm linear guide 136) and gantry (e.g., the pusher arm 134) to a primary linear guide (e.g., the build plate arm linear guide 138) and gantry (e.g., one or both of the vertical build plate arm 131 and the horizontal build plate arm 133) via a point of contact that is not rotationally constrained about the axis of moment loading (e.g., the connector 140), deflection is prevented or otherwise minimized. The point of contact between the primary and secondary gantry can be near a center of the vertical build plate arm 131. When a load is applied to the build plate 130, the majority of moment loading can be adopted by the secondary linear guide and gantry, which includes a load cell and is coupled to a drive mechanism. The primary linear guide and gantry can be coupled to the build plate and can experience substantially less moment loading than the secondary gantry.

Although the present disclosure primarily focuses on the use of a build plate drive system in conjunction with a vat polymerization printing apparatus that operates in a bottom-up configuration, a person skilled in the art will appreciate a build plate drive system can also be implemented into an additive manufacturing printer that operates in a top-down configuration. Likewise, a build plate drive system of the present disclosure can also be operated using printers that do not have a traditional vat set-up in which the resin being cured is still disposed within the volume of the reservoir in which the resin was being held prior to being cured. For example, the resin for being cured may be added into a print reservoir that houses only a limited supply of the resin to be cured, with additional resin being cycled into and out of the print reservoir from a bigger vat of resin. By way of further example, the print reservoir may just be a layer, such as a film or other release surface on which the resin to be cured can be disposed, allowing resin to be selectively cured from the release surface to become part of the object being manufactured. Accordingly, a person skilled in the art, in view of the present disclosures, will appreciate that references herein to print reservoirs (e.g., the print reservoir 50 and other reservoirs provided for herein, often with a “50” at the end of the reference number) and bases (e.g., the base 52 and other bases provided for herein, often with a “52” at the end of the reference number) can be equally applicable to an additive manufacturing printer that includes a release surface that is substantially opposed to the build plate in a similar manner that bases provided for herein are substantially opposed to the build plate.

Printing Processes

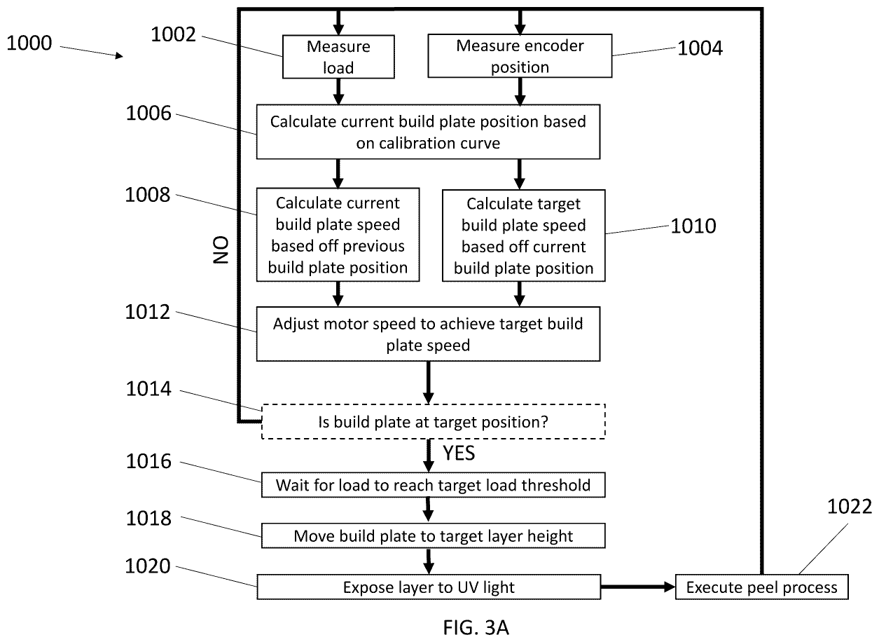

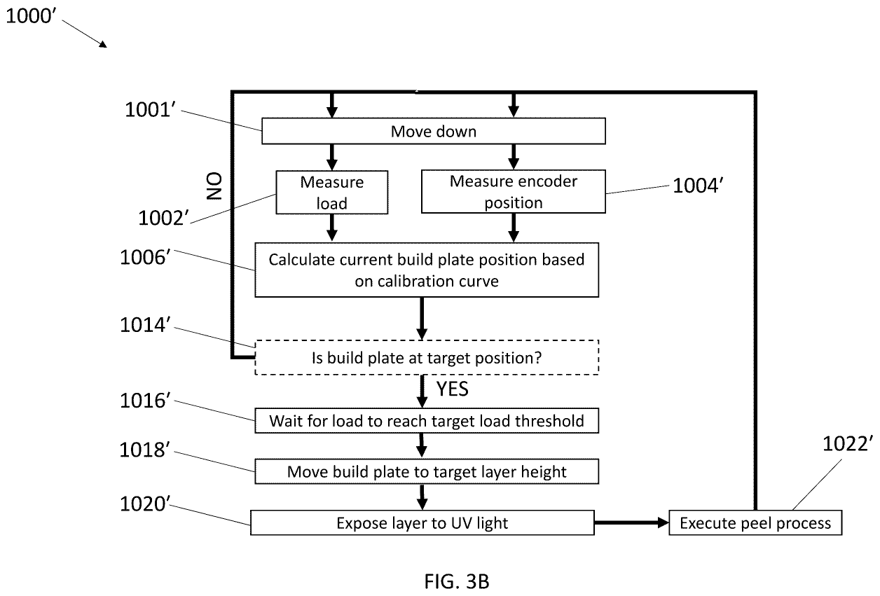

FIG. 3A illustrates one non-limiting embodiment of a printing process 1000 that can be carried out, for example, on the printer 110. As shown, one or more measurements can be performed using various sensors, transducers, and the like incorporated into the build plate drive system 100 and/or the printer 110. The measurements of the process 1000 can include a measure of load on the build plate 130 by the load cell 144 at an action or step 1002, as well as a measure of movement by the vertical build plate arm 131, and thus the build plate 130, by the linear encoder 146 at an action or step 1004.

Based on these one or more measurements, a current build plate position can be calculated at an action or step 1006, for example based on a calibration curve derived from the one or more measurements. A person skilled in the art will understand how to generate a calibration curve based on the measurements of load and/or linear movement, and thus further discussion of the same is unnecessary.

Additional calculations can be performed as part of the process 1000. For example, as shown at action or step 1008, a current speed of travel of the build plate 130 can be calculated at least based on one or more previous build plate positions. By way of further example, as shown at action or step 1010, a target speed of travel of the build plate 130 can be calculated at least based on a current build plate position. That is, as provided for by the present disclosure, the build plate speed can be a function of build plate position (e.g., a height of the built plate). After determining a current and target build plate speed, the process 1000 can include adjusting parameters that control a build plate speed. This can include, as shown, an action or step 1012 of adjusting a motor speed to achieve, or to work towards achieving, the target build speed.

The process 1000 can continue at an action or step 1014, which can include determining if the build plate 130 has reached the target position. If it has not reached the target position, the process 1000 can return to earlier actions or steps, such as the action(s) or step(s) of measuring parameters such as a load at step 1002, or a position at step 1004. If the build plate 130 has reached the target position, then the process 1000 can include an action or step 1016 of waiting for a load to reach or exceed a target load threshold. Upon achievement of the same, the process 1000 can include moving the build plate 130 to a target layer height, as shown at action or step 1018, and performing a printing step, such as exposing a layer to UV light at action or step 1020. Upon completion of the printing process, an action or step 1022 of executing a peel process to remove the printed part from the build plate 130 can be performed, and the build plate 130 can be cleaned and/or used again for a further print.

FIG. 3B illustrates another non-limiting embodiment of a printing process 1000′ that can be carried out, for example, on the printer 110. The process 1000′ can be considered a more simplified version of the process 1000 described above with respect to FIG. 3A. As shown a build plate, such as the build plate 130, can be moved down (though other movements, such as up, are possible) to set an initial location of the build plate 130 to initiate the print job, at an action or step 1001′. As shown, one or more measurements can be performed using various sensors, transducers, and the like incorporated into the build plate drive system 100 and/or the printer 110. The measurements of the process 1000′ can include a measure of load on the build plate 130 by the load cell 144 at an action or step 1002′, as well as a measure of movement by the vertical build plate arm 131, and thus the build plate 130, by the linear encoder 146 at an action or step 1004′.

Similar to the process 1000, based on these one or more measurements, a current build plate position can be calculated at an action or step 1006′, for example based on a calibration curve derived from the one or more measurements. Unlike the process 1000, actions of calculating current and target speeds, and making adjustments in view of the same, can be omitted, instead jumping straight to an action or step 1014′ of determining if the build plate 130 has reached the target position. If it has not reached the target position, the process 1000′ can return to earlier actions or steps, such as the action(s) or step(s) of measuring parameters such as a load at step 1002′, or a position at step 1004′. If the build plate 130 has reached the target position, then the process 1000′ can include an action or step 1016′ of waiting for a load to reach or exceed a target load threshold. Upon achievement of the same, the process 1000′ can include moving the build plate 130 to a target layer height, as shown at action or step 1018′, and performing a printing step, such as exposing a layer to UV light at action or step 1020′. Upon completion of the printing process, an action or step 1022′ of executing a peel process to remove the printed part from the build plate 130 can be performed, and the build plate 130 can be cleaned and/or used again for a further print.

In both the process 1000 and the process 1000′, the printing process can more generally involve first “over-plunging” the drive position by advancing it distally past a target drive position, sometimes referred to as a target layer position, at which the printing is designated to occur. More specifically, the process can involve moving a drive point downwards, past a target drive position, into a print reservoir having resin (e.g., high viscosity resin) disposed therein. As provided for herein, the drive point or drive position is a point or position that is being controlled by a driver or other similar mechanism, which in turn controls a location or position of the build plate. Accordingly, in an embodiment such as the system 100, the drive point can be a designated point or location on the lead screw 142. The resin can cause the build plate to deflect without the build plate naturally returning to its undeflected position at a sufficient speed for the printing process. For example, a build plate may not return to its undeflected position within approximately 30 seconds. When the drive position is advanced distally beyond the desired position where the curing step of the next layer is to begin, i.e., the target drive position, it can be described as moving to an “over-plunged position,” and as provided for herein, the systems, devices, and methods can set a designated or desired over-plunged position to which the drive position is to reach prior to moving it upwards towards the target drive position. The over-plunged position is at a location or position that is closer to the reservoir base than the target drive position. Notably, as provided for herein, while a processor or the like may command a driver to move a drive point towards an “over-plunged” position, that position may not ever be achieved by the build plate, for example because the viscous resin through which the build plate is plunging may be applying a force on the build plate, causing it to deflect above the “over-plunged” position of the build plate. Still, the system itself can command the driver to try, or keep trying, to achieve the “over-plunge” position as part of the various processes provided for herein. That is, achieving a commanded position is not necessary.

Homing Process

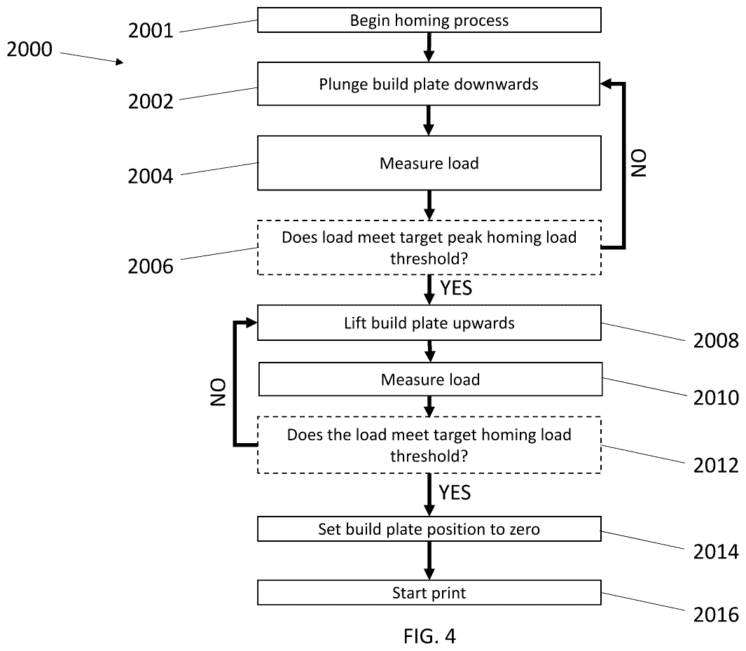

FIG. 4 illustrates a non-limiting embodiment of a homing process 2000 performed to set a location of a build plate, such as the build plate 130 of the printer 110, prior to beginning a print job. As described in greater detail below, the process is designed for the build plate 130 to first “over-plunge,” meaning that it advanced further distally, or downwards, into the resin than where it will be positioned when a print job begins, before it is then raised to a designated or preferred zero position, which is the desired position where the print job is to begin.

The homing process can be begin at action or step 2001. This can lead, for example, to plunging the build plate downwards, as shown at action or step 2002. Load on the build plate can then be measured or otherwise determined, as shown at action or step 2004. This can be done by a load cell, such as the load cell 144, and/or using other techniques for determining a load on an object known to those skilled in the art. Thereafter, an action or step 2006 involving a check to determine if a target peak homing load threshold or value has been met (or exceeded) can be performed. This check can involve, by way of example, comparing the measured load from step 2004 to the target peak homing load value. The target peak homing load value can be a predetermined value that is indicative of a load being applied to the build plate that exceeds the desired load when the print job is to begin, meaning the build plate is disposed distally or further downwards than where it is desired to be located at the start of a print job. This can be referred to as a designed “over-plunge,” and can include pressing the build plate into the glass and/or film (e.g., a transparent release film). In some exemplary embodiments, the target peak homing load value is approximately in the range of about 100 Newtons to about 2000 Newtons, and in some embodiments it can be about 1200 Newtons, though a person skilled in the art will appreciate a variety of factors that can impact a value for the target peak homing load value, including but not limited to parameters and configurations of other parts of the printer, as well as the material being used to print, among others.

If the check at the step 2006 is that the value of the target peak homing load has not yet been achieved, the process 2000 can include further plunging the build plate downwards by returning to the step 2002. However, if the check at the step 2006 is that the value of the target peak homing load has been achieved or exceeded, the process can advance to action or step 2008 by lifting the build plate upwards, i.e., in a direction opposite to the direction at which it was advanced at step 2002, towards an anticipated position zero at which printing can commence in view of the previous “over-plunge.” After a move at step 2008, a load on the build plate can be measured, as shown by action or step 2010. This can also be done by a load cell, such as the load cell 144, and/or using other techniques known to those skilled in the art. Upon obtaining a value of the measured load, a check of how that measured load compares to a target homing load threshold or value can be performed, at action or step 2012. Similar to step 2006, this check can involve, by way of example, comparing the measured load from step 2010 to the target homing load value. The target homing load value can be a predetermined value that is indicative of a load being applied to the build plate when the build plate is disposed at a location where the printing onto the build plate is designed to start. In some exemplary embodiments, the target homing load value is approximately in the range of about 100 Newtons to about 2000 Newtons, and in some embodiments it can be about 1200 Newtons, though a person skilled in the art will appreciate a variety of factors that can impact a value for the target homing load value, including but not limited to parameters and configurations of other parts of the printer, as well as the material being used to print, among others.

If the check at the step 2012 is that the value of the target homing load has not yet been achieved, the process 2000 can include further lifting the build plate upwards by returning to the step 2008. However, if the check at the step 2012 is that the value of the target homing load has been achieved or exceeded, the process can advance to action or step 2014, which can include setting a build plate position to zero. Thereafter, at action or step 2016, a print job can be initiated.

A person skilled in the art will appreciate how the various actions and steps in the processes 1000, 1000′, and 2000 can be adapted for other printing methods, such as other types of additive manufacturing, including but not limited to other types of vat polymerization printing processes. By way of example, while the present disclosure describes the printing processes 1000, 1000′ and the homing process 2000 with respect to a bottom-up DLP printing technique, a person skilled in the art will appreciate that for a top-down DLP printing technique, actions such as plunging a build plate downwards or lifting a build plate upwards may actually be reversed for a different printing technique such that the action of “plunge build plate downwards” may be “move build plate upwards” and “lift build plate upwards” may be “move build plate downwards.”

Further details about the homing process, and related embodiments, is described below in the “BUILD PLATE TRACKING” and “Z-POSITION CONTROL” sections. Nevertheless, the process of determining and/or relying upon a target peak homing load is a process that can be independent from build plate tracking, Z-position control, and achieving zero load at cure targets.

Calibration and Testing

The spring behavior (deflection vs load) between the build plate and glass can be first calibrated, for example, by pressing the build plate into the glass and film (e.g., a transparent release film), the above-described “over-plunge” with respect to FIG. 4. For example, and with reference to FIGS. 2A-2C, as the lead screw 142 drives the pusher arm 134 downwards, the build plate 130 can be loaded against the glass base 152 and film (not labeled). An assumption can be made that the distance between the film and build plate 130 can be zero once loads are greater than 0 Newtons. The load and deflection measured approximately between about 0 Newtons and about 2000 Newtons can be used to calibrate the position of the linear encoder 146 relative to the position of the build plate 130 as a function of the measured load on the build plate. The position of the pusher arm linear guide 136 relative to the position of the build plate 130 can also be calibrated as a function of the measured load on the build plate 130.

It is not typically feasible to directly measure the position of the build plate with the necessary accuracy for the printing process, especially when high loads are applied to the build plate. However, the theoretical position of the build plate can be calculated from a combination of a measured position, a measured load on the build plate, an/or calibration data describing the relative position of the build plate to the measured position as a function of the load applied on the build plate. Processes for measuring this calibration data are described in FIGS. 5A-6B.

Notably, the “over-plunged position” and the “theoretical position” provided for herein are different. The “over-plunged position” defines a drive point that is past a target layer height. It refers to a position of the drive point, not the build plate. In practice, the drive point reaches the over-plunged position, but this position may never be achieved by a build plate. Whether the build plate reaches the over-plunged position can depend, at least in part, on how much force is applied on the build plate, which can cause it to deflect upwards away from the reservoir base. Further, the build plate may or may not be deflected during an “over-plunge” action, as that can likewise depend, at least in part, on how much force is applied back on the build plate by the resin. The “theoretical position” refers to calculating where the build plate actually is based on a measured position (often provided by an encoder), a measured force on the load cell, and/or calibration data that describes the relative position of the build plate to the measured position as a function of the applied force on the load cell. A controller, as provided for herein or otherwise known to those skilled in the art, can direct an “over-plunge” independently of whether it is calculating the theoretical build plate position, although a controller can be involved in both. For example, if the controller switches its “control point” from the drive position to the build plate position, the drive position will inherently over-plunge if any load is applied to the resin.

FIGS. 5A and 5B illustrate a schematic side view of a build plate drive system 700 of a printing apparatus 710 being used with a hemispherical test fixture 704, the drive system 700 and printing apparatus 710 being similar to other embodiments of such systems and apparatuses described herein. The hemispherical test fixture 704 can ensure a single point of contact to transmit load between a build plate 730 and a glass base 752 of a print reservoir 750. As shown, the printing apparatus 710 can include a Z-axis tower or housing 702 in which components of the printing apparatus 710 and the build plate drive system 700 are disposed. This includes a linear rail 732, a lead screw 742, a horizontal build plate arm 733, a vertical build plate arm 731, which in some instances can be considered part of the build pate 730 with the horizontal build plate arm 733 being considered “the build plate arm,” and a pusher arm 734 having a load cell 744 associated with the pusher arm 734. As with other embodiments, the pusher arm 734 can be coupled to the horizontal build plate arm 733 at a connector 740, such as by way of a pin-in-slot connection. Still further, other components of the printing apparatus 710 and the build plate drive system 700 disposed in the Z-axis tower 702 can include a build plate linear guide 738 that couples the horizontal build plate arm 733 to the rail 732, and a pusher linear guide 736 that couples the pusher arm 734 to the rail 732 and is also actionably coupled to the lead screw 742 such that the lead screw 742 imparts a force on the pusher linear guide 736, which in turn can impart a force on the build plate 730. Similar to other embodiments, a linear encoder 746 or other similar device can be provided in conjunction with the build plate linear guide 738. As shown, a stepper motor 739 can be provided to actuate the lead screw 742, although other components capable of driving a lead screw or other similar component can be used.

FIG. 5A illustrates the printing apparatus 710 and the build plate drive system 700 in an unloaded configuration in which the stepper motor 739 is not actuating the lead screw 742. As shown, the build plate 730 is substantially parallel with respect to the glass base 752 of the print reservoir 750. FIG. 5B illustrates the printing apparatus 710 and the build plate drive system 700 in a loaded configuration in which the stepper motor 739 actuates the lead screw 742 as part of a machine calibration procedure. More particularly, the lead screw 742 is rotated, which in turn can cause the pusher linear guide 736 to move vertically downwards, as shown by arrow F, with respect to a longitudinal axis Ls extending longitudinally through the lead screw 742. The pusher linear guide 736 can also move downwards along the rail 732, as shown in FIG. 5B, with a distance 737 between the guides 736, 738 getting smaller. The downward movement of the pusher linear guide 736 can cause a force to be supplied by the pusher linear guide 736 in the downward direction of arrow F. Further, the downward movement of the pusher linear guide 736 can cause a first end 734a of the pusher arm 734 to move vertically downwards along the rail 732 in the same direction of arrow F. A force represented by arrow G is applied upwards on the build plate 730. This force can be equal and opposite to the force represented by the arrow F. A second end 733b of the horizontal build plate arm 733, the vertical build plate arm 731, the build plate 730, and the hemispherical test fixture 704 all remain nearly stationary during this calibration procedure. Position data from the encoder 746 and the lead screw 742 can be measured as different forces F are applied to the pusher linear guide 736 by the lead screw 742. This calibration data can be used, for example, to track the theoretical position of the build plate 730 as a function of the measured force from the load cell 744 and the measured position of the encoder 746 or the measured position of the pusher linear guide 746. The foregoing notwithstanding, this design minimizes the amount the build plate 730 moves with respect to the glass base 752, and further, the present disclosure provides for various control loops and other systems to further minimize the impact of build plate deflection.

FIGS. 6A and 6B illustrate a schematic side view of another build plate drive system 800 of a printing apparatus 810 being used with a hemispherical test fixture 804, the drive system 800 and printing apparatus 810 being similar to other embodiments of such systems and apparatuses described herein. Like the hemispherical text fixture 704, the hemispherical test fixture 804 can ensure a single point of contact to transmit load between a build plate 830 and a glass base 852 of a print reservoir 850 as a part of a calibration procedure. As shown, the printing apparatus 810 can include a Z-axis tower or housing 802 in which components of the printing apparatus 810 and the build plate drive system 800 are disposed. This includes a linear rail 832, a lead screw 842, a horizontal build plate arm 833, a vertical build plate arm 831, which in some instances can be considered part of the build plate 830 with the horizontal build plate arm 833 being considered “the build plate arm,” and a build plate linear guide 838 that couples to both the linear rail 832 and the lead screw 842. As with other embodiments, a linear encoder 846 or other similar device can be provided in conjunction with the build plate linear guide 838. By coupling the build plate linear guide 838 to both the linear rail 832 and the lead screw 842, which is different than the configuration illustrated in FIGS. 5A and 5B, movement of the guide 838 via the lead screw 842 can also cause movement of the guide 838 along the rail 832. Similar to other embodiments, a stepper motor 839 can be provided to actuate the lead screw 842, although other components capable of driving a lead screw or other similar component can be used.

FIG. 6A illustrates the printing apparatus 810 and the build plate drive system 800 in an unloaded configuration in which the stepper motor 839 is not actuating the lead screw 842. As shown, the build plate 830 is substantially parallel with respect to the glass base 852 of the print reservoir 850. FIG. 6B illustrates the printing apparatus 810 and the build plate drive system 800 in a loaded configuration in which the stepper motor 839 actuates the lead screw 842. More particularly, the lead screw 842 is rotated, which in turn can cause the build plate linear guide 838 to move vertically downwards, as shown by arrow F₁, with respect to a longitudinal axis L₆ extending longitudinally through the lead screw 842. In response, the build arm linear guide 838 also moves downwards with the lead screw 842 and along the rail 832. In response, the hemispherical test fixture 804 applies an equal and opposite force F₁ on the build plate, i.e., in the direction illustrated by the arrow G₁. A second end 833b of the horizontal build plate arm 833, the vertical build plate arm 831, and the build plate 830 are nearly stationary during this test. Position data from the encoder 846 and the lead screw 842 can be measured as different forces F₁ applied to the linear guide 838 by the lead screw 842. This calibration data can be used to track, for example, the theoretical position of the build plate 830 as a function of the measured force and the measured position of the encoder 838 or the measured position of the lead screw 842.

Build Plate Tracking

The control loop implemented to achieve the target layer height with zero load at cure can be referred to as “build plate tracking.”

During the printing process, the build plate position can be calculated based on the measured load, measured encoder position, and the calibration data of the system. Alternatively, or additionally, the build plate position can be calculated based on the measured load, measured pusher arm linear guide position, and the calibration data of the system. The printer can achieve precise accuracy of the build plate position at the target layer height based on controlling the theoretical build plate position and velocity. The velocity of the build plate can be controlled to 0 um/s as the calculated build plate position reaches a target layer height. This exit criteria may bring the load on the build plate towards zero at the target layer height.

A control loop provided for or otherwise related to this subsystem is the homing process for the printer, an example of which is described above with respect to FIG. 4. In conjunction with starting a print, the machine can: a) cure a very thin layer at a large cross section due to the size of the build plate; and b) set the zero position of the printer, which can be a critical reference for the rest of the print. A homing algorithm can start by plunging the build plate into the glass and increasing force to a very high load (e.g., about 1200 Newtons) so that resin can be forced out from under the build plate. The build plate can then slowly be lifted towards a lower load (e.g., about 100 Newtons) so that it is still in contact with the glass but not significantly deflecting. The build plate position can then be set to 0 um at this load. The encoder position can be set to a negative value based on the calibration curve of the build plate position against measured load and encoder position. This position can be used, for example, as the zero reference for the remainder of the print. The first UV image can be exposed onto the build plate at any point during this process.

To print a part quickly, it can help to plunge the build plate as fast as possible towards the reservoir glass to force the part down to the target layer height. However, if a part is plunged too quickly towards the build plate the force pushing up on the part created by the variables in Stefan's equation may be great enough to either deform or break the feature(s) being printed. This can be risky, for instance, with small features while printing high viscosities. By rearranging Stefan's equation, the build plate speed (dH/dt) can be controlled as a function of the height of the previous layer above the glass (H) to maintain a target force F:

$$\frac{dH}{dt} = - \frac{2 {FH}^{3}}{3 {ηπ}^{2} {R}^{4}}$$

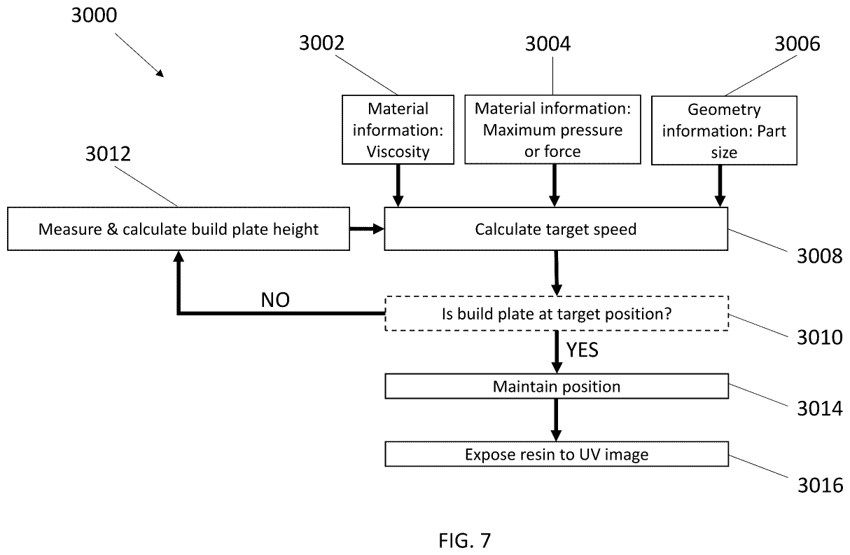

This control curve can be used to control, for example, the speed of the motor driving the build plate as it approaches the target layer height. To print a material as fast as possible without damaging the printed part, a control scheme 3000, such as the one illustrated in FIG. 7, can be utilized. As shown, the control scheme 3000 allows information to be provided to a controller or the like that is part of and/or in communication with a printing apparatus. This information can include at least one or more of material information and/or geometry information. Material information can include, for example, the viscosity of the material, as shown at input 3002. Geometry information can include, for example, a part size, as shown at input 3006. The geometry of the part can be represented by an R value, which can be derived from software that slices a CAD file into images for printing. This R value can change from layer-to-layer of the print. Another example of material information can include, for example, a maximum pressure or force that a part can withstand without failing, as shown at input 3004. A user can determine a maximum allowable force, F, to input, and a person skilled in the art will understand how such a determination can be made. Any combination of these parameters, and/or certain other parameters appreciated by those skilled in the art, can be used to calculate the target build plate speed at any measured height, as shown at step or action 3008.

This approach may be further generalized by replacing F with a pressure-driven relationship:

F=PA

where P is the pressure and A is the area of the part. The area of a cylindrical feature may be represented by:

A=πR²

which yields:

F=PπR²

Substituting into the equation for build plate speed yields:

$$\frac{dH}{dt} = - \frac{2 {PH}^{3}}{3 {ηπ}^{2} {R}^{4}}$$

In this case, a user can determine what pressure a material can withstand during plunge. This value can be agnostic to the geometry of the part. The speed can be scaled appropriately based on the R value describing the size of the part determined by the slicing software.

In most practical cases, the geometry of the part being printed is not a cylinder as described by Stefan's equation. The slicing software can simplify any geometry by calculating an appropriate R value to describe the fluid dynamics of a part.

In some implementations, the equation may be simplified for the user to input more generic information about, for example, plunge speed, while maintaining the relationship of adjusting build plate speed based on build plate height. This approach can allow for the user to control plunge dynamics without requiring a deep level of understanding about the underlying variables. The build plate speed equation can be simplified to:

$$\frac{dH}{dt} = α {H}^{3} , where α = - \frac{2 F}{3 {ηπ}^{2} {R}^{4}}$$

where α is a simplified parameter that the user can input to adjust plunge forces. The build plate can be driven at a speed equal to the lesser of a maximum speed that the machine can move at, or the equation

$$\frac{dH}{dt} = α {H}^{3} .$$

A maximum force threshold for the build plate can also be defined. If the measured force exceeds the maximum force threshold during any time of the plunge, α may be recalculated as

$$α = \frac{dH}{dt} \frac{1}{{H}^{3}}$$

at that time. The new value of α can result in a force limited near the maximum force threshold during the remainder of the plunge.

After the build plate target speed has been calculated, it can be determined if the build plate is at a target position, as shown at action or step 3010, the target position being a predetermined position input by a user and/or determined using some of the techniques provided for herein or otherwise known to those skilled in the art. If the target position has not been achieved, a build plate height can be measured and/or calculated, as shown at action or step 3012, and input along with the previously input information (e.g., viscosity, maximum pressure or force, and/or part size), to again calculate the target speed until it is determined the build plate is at the target position. After it is determined that the build plate is at the target position, the position can be maintained, as shown at action or step 3014, and resin disposed in a print reservoir and associated with the build plate can be exposed to an ultraviolet (UV) image to cure the same as part of the printing action, as shown at action or step 3016.

Further, the present disclosure contemplates still other embodiments of processes, including but not limited to the printing and homing processes provided for herein. By way of non-limiting example, instead of calculating a theoretical build plate position based on a measured encoder position and/or load, the build plate position can be directly measured relative to the glass base. Alternatively, the position of the bottom of the part can be directly measured relative to the glass base. By way of still further non-limiting example, instead of measuring the load on the build plate using a load cell, the load can be measured by measuring the amount of torque delivered by the driving stepper motor.

A person skilled in the art, in view of the present disclosures, will appreciate there are many different ways to adjust speed as the build plate plunges towards the reservoir. However, because most, if not all, DLP printers follow the same fluid mechanics as Stefan's equation, this method is highly efficient at maximizing speed within the physics of the system.

Z-Position Control

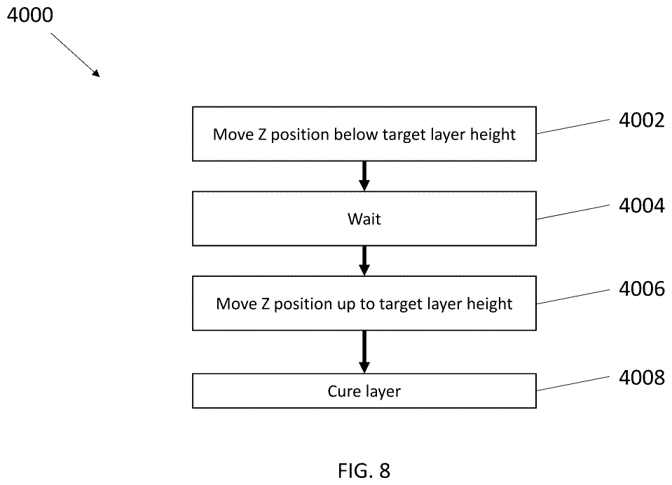

FIG. 8 illustrates one non-limiting process 4000 of implementing Z-position control in conjunction with performing additive manufacturing. The Z-position relates to the vertical positioning of a gantry coupled to a build plate on which a part will be printed, or similar system to provide support and/or movement as desired. The gantry can be, in at least some instances, portions or all of the build plate drive system 100, as well as other embodiments of build plate drive systems provided for herein, such as build plate drive systems 300, 400, 500 and 600. Accordingly, the Z-position can be a location of one or more of the horizontal build plate arm 133, pusher arm 134, pusher arm linear guide 136, build plate linear guide 138, pin-in-slot connection 140, and/or other related components, and similar and/or related components of other build plate drive systems provided for herein. The Z-position may be determined, for example, by counting steps that a motor is rotated, measuring a rotary encoder on the motor or lead screw, operating a linear encoder, etc.

The implementation provides control in the Z-direction by measuring, determining, or otherwise knowing (e.g., having that information inputted in some fashion) a desired or target Z-position to achieve a desired layer height and controlling the measured Z-position such that it first goes below the target Z-position before then being moved up to the target Z-position, referred to herein as “over-plunging.” The target Z-positions can include, for example, the “over-plunged position” and the “target build plate position,” among other positions provided for herein. As shown at action or step 4002, the Z-position can be moved to below a target layer height, also referred to as a first position along a Z-print axis and/or an over-plunged position. Subsequently, a period of time can pass, indicated as a “wait” action or step 4004 in FIG. 8, after which the build plate can have its Z-position moved up to the target layer height, also referred to as a second position along the Z-print axis and/or a target build plate position, as shown at action or step 4006. The time to wait can be determined by a person skilled in the art in view of the present disclosures (e.g., approximately five seconds). Alternatively, the period of time can be determined based on the measured load decreasing below a load at cure threshold. After moving the Z-position to the target layer height, the layer can be cured, as shown at action or step 4008. The layer can be cured while the build plate is disposed at the second position. These steps can be repeated as desired in conjunction with building a three-dimensional object. Notably, while the measured position of the Z-axis can be controlled to a height below a target layer height, the build plate may, but does not necessarily, go below that target layer height due, at least in part, to mechanical deflection. An embodiment of a printing apparatus 610 that implements the Z-position control illustrated in FIG. 8 provides a simple implementation of a way to force fluid out from between a part being printed and a release film into a thin layer more quickly.

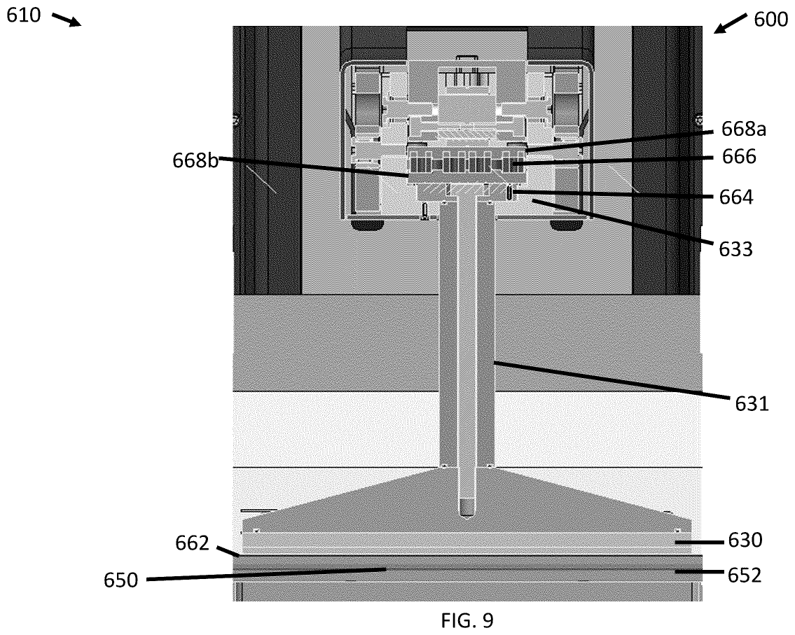

The present disclosure also provides for ways by which the build plate can be leveled and/or homed. One exemplary system for leveling and homing a build plate 660 of a build plate drive system 600 of the printing apparatus 610 is illustrated in FIG. 9.

It is typically advantageous for a layer thickness between a build plate 660 and release film 662 to be nearly uniform immediately prior to beginning a print. If a surface of the build plate 660 is misaligned to a top surface of the platform, e.g., a glass base 652 of a print reservoir 650, that supports the release film 662, a thickness of the first layer will typically be non-uniform. To overcome this misalignment, as shown in FIG. 9, a build plate flange 664 can be compressed downwards on the horizontal build plate arm 633, for example by a compression component 666, to provide a homing process. The compression component 666 can be, for example, an array of springs disposed between two substantially parallel plates 668a, 668b. A compressive force on the top plate 668a can be translated to the build plate 630 through the array of springs 666. A person skilled in the art will appreciate other designs and features that can be used in lieu of, or in addition to, an array of springs to translate a compression force onto the build plate 630, in at least some instances via a vertical build plate arm 631. When the build plate 630 is lowered into contact with the release film 662, the array of springs 666 can be compressed so that the build surface of the build plate 630 becomes more parallel with the glass base 652 and the release film 662, thereby homing the build surface of the build plate 630 with respect to the release film 662 and/or the glass base 652. If the force applied during the homing process is slightly less than the total force exerted downwards by the spring array 666, then a parallel surface can be achieved without creating an error in the “zero” Z-position achieved through the process of FIG. 4. On the subsequent layers of the print, the build plate 630 can automatically tilt back to its non-parallel original position. The result can be a printed part with minor error in its Z-height, which matches the misalignment error of the build plate 630 to the glass base 652 and the film 662.

### Impact, Benefits, and Other Embodiments

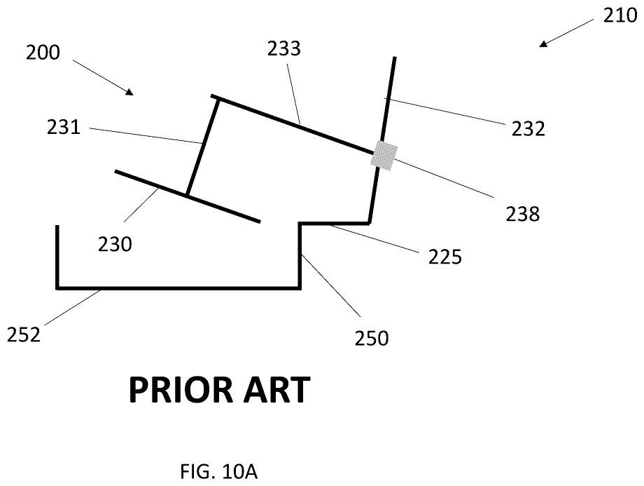

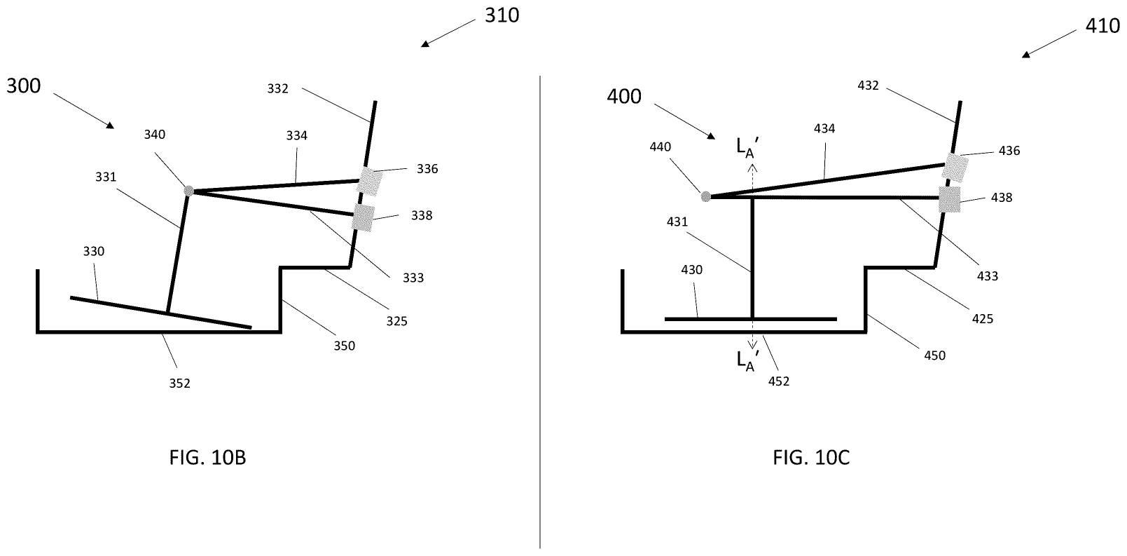

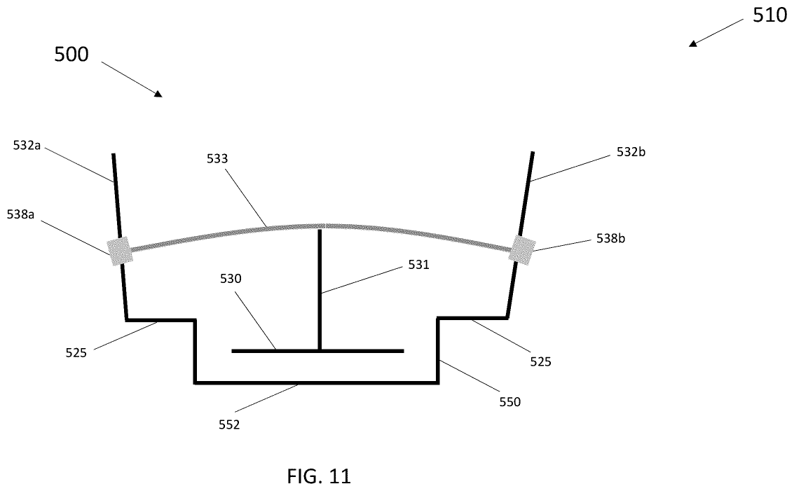

FIG. 10A provides for a schematic illustration of a build plate drive system 200 of a printing apparatus 210 of the prior art. The schematic illustration is simplistic in nature, and thus omits a variety of features that may be included in a typical additive manufacturing printer. The figure is included to illustrate how rotation of a build plate linear guide 238 can create substantial deflection between a glass base 252 of a print reservoir 250 of the printer 210. As shown, the printer 210 includes a Z tower, which can include a rail 232 that can be associated with a frame 225 of the printer 210. The frame 225 can be coupled to the print reservoir 250, the reservoir including the glass base 252. A horizontal build plate arm 233 can be coupled to the rail 232 by way of a build plate linear guide 238, the guide 238 being able to translate substantially vertically up and down the rail 232 as shown. A vertical build plate arm 231 can be coupled to the horizontal build plate arm 233, the arm 231 coupling a build plate 230 to the horizontal build plate arm 233, and thus the rail 232. Accordingly, movement of the horizontal build plate arm 233 with respect to the rail 232 can also effect movement of the build plate 230 with respect to the rail 232. As shown, both the Z axis tower and the build plate linear guide 238 can rotate due to moment loading. A small rotation in the build plate linear guide 238 can create a substantial deflection between the build plate 230 and the glass base 252, thus preventing these two opposed surfaces from being substantially parallel to each other.

Besides rotation of the build plate linear guide 238, deflection from other system components, such as the Z-tower (e.g., the rail 232) and reservoir stage (e.g., the frame 225), may create further potential rotation issues. In a single-tower Z axis design like shown in FIG. 10A, the tower, shown as the rail 232, typically tilts backwards some amount. This backwards tilt can cause the build plate 230 to tilt out of parallel alignment with the glass base 252. When the build plate 230 is not parallel to the glass base 252, one edge of the build plate 230 may contact the glass base 252 before the rest of the build plate 230. This contact limits how much force can be applied to the build plate 230 to push fluid out.

The impact of other components of a printer still causing a build plate to not be substantially parallel to a glass base of a reservoir is schematically illustrated in FIG. 10B. As shown, a build plate drive system 300 of a printer 310 includes features akin to those described above with respect to the system 100 of the printer 110 of FIGS. 2A-2C, such as a build plate 330 that can be moved substantially vertically up and down a rail 332, the rail being part of a Z tower, as well as a pusher arm 334, a pusher linear guide 336, a vertical build plate arm 331, a horizontal build plate arm 333, a build plate linear guide 338, and a pin-in-slot connection 340 formed between the pusher arm 334 and the horizontal build plate arm 333. The build plate 330 can be moved along the rail 332, via the various components of the system 300 (e.g., the arms 331, 333, 334 and guides 336, 338), so that it can be moved vertically towards and/or away from a glass base 352 of a print reservoir 350 of the printer 310. As shown, a frame 325 can couple the print reservoir 350 to the Z tower, e.g., the rail 332.

In the illustrated embodiment, the configuration of the build drive plate system 300, including the pin-in-slot connection 340, reduces or eliminates rotation of the build plate guide 338. However, as shown, because deflection from other system components can also impact whether the build plate 330 is parallel to the glass base 352, rotation of the horizontal build plate arm 333 upwards as the Z tower rotates can prevent a parallel relationship being maintained between the build plate 330 and the glass base 352.

Accordingly, to help combat the impact of rotation by other components of the system on the desired parallel configuration between a build plate and a glass base of a print reservoir, a further alternative design is schematically illustrated in FIG. 10C. Similar to the build plate drive system 300, a build plate drive system 400 of a printer 410 includes features akin to those described above with respect to the system 100 of the printer 110 of FIGS. 2A-2C, such as a build plate 430 that can be moved substantially vertically up and down a rail 432, the rail being part of a Z tower, as well as a pusher arm 434, a pusher linear guide 436, a vertical build plate arm 431, a horizontal build plate arm 433, a build plate linear guide 438, and a pin-in-slot connection 440 formed between the pusher arm 434 and the horizontal build plate arm 433. The build plate 430 can be moved along the rail 432, via the various components of the system 400 (e.g., the arms 431, 433, 434 and guides 436, 438), so that it can be moved vertically towards and/or away from a glass base 452 of a print reservoir 450 of the printer 410. As shown, a frame 425 can couple the print reservoir 450 to the Z tower, e.g., the rail 432.

The embodiment of FIG. 10C differs from the embodiment of FIG. 10B because the pinned connection (e.g., the pin-in-slot connection 430) between the pusher arm 434 and the build plate arm 433 is disposed forward of the vertical build plate arm 431. As shown, the pinned connection 430 is disposed away from a longitudinal axis L_{A}′ that extends through an approximate center of the build plate 430, similar to the longitudinal axis L_{A} of FIG. 2C, further from the rail 432 than the longitudinal axis L_{A}′ is from the rail 432. The longitudinal axis L_{A}′ can be substantially normal to the upward-facing main surface of the glass base 452. By moving this connection 430 forward of a center the build plate 430, a moment can be created about the build plate guide 438. This moment can rotate the horizontal build plate arm 433 down towards the glass base 452. More particularly, the build plate guide 438 and the horizontal build plate arm 433 can rotate opposite the Z tower. The position of this pinned connection 440 can be tuned so that the rotation of the build plate guide 438 counteracts the rotational deflection from other components in the system, such as the Z-tower (e.g., the rail 432). If tuned properly, the build plate 430 can be kept substantially parallel to the glass base 452 as the printer 410 is loaded and unloaded. When the build plate 430 is maintained substantially parallel to the glass base 452, fluid can be pushed out from between the part and glass base 452 at higher loads without the edge of the build plate 430 tilting into contact with the glass base 452.

A further embodiment of a build plate drive system 500 of a printer 510 is schematically illustrated in FIG. 11. This design provides for a two-tower Z-axis design. As shown, the two Z towers comprise a pair of opposed rails 532a, 532b disposed on either side of a build plate 530. A horizontal build plate arm 533 can extend between the two Z towers, coupling to the rails 532a, 532b by way of build plate guides 438a, 438b, respectively. A vertical build plate arm or stem 531 can be coupled to or otherwise extend from or be associated with the horizontal build plate arm 533 to couple a build plate 530 to the horizontal build plate arm 533. As shown, a symmetric deflection of the Z towers can maintain a parallel orientation between the build plate 530 and a glass base 552 of a print reservoir 550, the print reservoir being coupled to the Z towers by way of a frame 525. When the rails 532 supporting the build plate 530 deflect symmetrically, the build plate 530 cannot tilt relative to the glass base 552.

Alternative approaches to the described embodiments are also accounted for herein. By way of non-limiting example, instead of a two-guide pusher arm design (e.g., the guides 136, 138, or equivalents in other designs), a single guide with a very high torsional stiffness can be used, for example, to improve the stiffness of the Z-tower (e.g., rail). One such embodiment of that design is illustrated and described above with respect to FIGS. 6A and 6B.

In DLP printing, the algorithms described herein, including but not limited to the processes 1000, 1000′, 2000, 4000 and control scheme 3000, can be used to control a build plate of a DLP printer towards a target layer height while also stopping all fluid flow caused by build plate motion before curing resin.

When printing new resins, such as on the Developer software platform offered by 3DFortify Inc., these algorithms are capable of printing without requiring customization of machine movement parameters specific for a certain resin viscosity and/or geometry of a part to be printed. The result is a faster path to successful printing of new materials on printers, such as the FLUX printers referenced above, because the user spends less time customizing machine operation for the material.

When printing injection mold tools, very high forces can be generated without tilting the build plate relative to the glass. This means that layers can be printed quickly without much time spent on the plunge process. This can be key in injection mold tooling applications at least because of the large cross sections of injection mold tools.

The combination of stiffness and the build plate control algorithm(s) provided for herein can also be key for starting prints. The user can force fluid down to a homing thickness even in highly viscous fluids, without the need for cutting holes or grooves in the build plate surface.

Computer System for Implementation

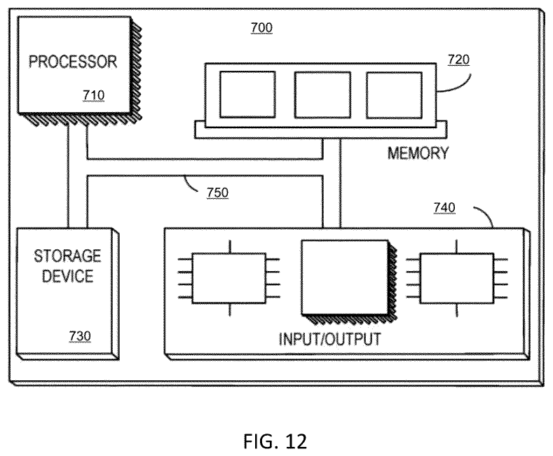

The processes, control schemes, and other algorithms provided for herein can be performed by at least one processor and/or controller that can be part of the printing apparatus and/or can be in communication with the printing apparatus. That is, implementation of the present disclosures on a computer readable medium can include a central processing unit (CPU), memory, and/or support circuits (or I/O), among other features. In embodiments having a memory, that memory can be connected to the CPU, and may be one or more of a readily available memory, such as a read-only memory (ROM), a random access memory (RAM), floppy disk, hard disk, cloud-based storage, or any other form of digital storage, local or remote. Software instructions, algorithms (e.g., processes and control schemes disclosed herein), and data can be coded and stored within the memory for instructing the CPU. Support circuits can also be connected to the CPU for supporting the processor in a conventional manner. The support circuits may include conventional cache, power supplies, clock circuits, input/output circuitry, and/or subsystems, and the like. Output circuitry can include circuitry allowing the processor to control the build plate drive systems, in whole and/or in part, as well as other components of a printing apparatus, including but not limited to a magnetic field generator, a light source and/or radiation source, and/or other components of an additive manufacturing printer. A non-limiting one embodiment of a computer system 700 with which the present disclosures can be used and/or implemented is illustrated in FIG. 12.

More particularly, FIG. 12 is a block diagram of one exemplary embodiment of a computer system 700 upon which the present disclosures can be built, performed, operated, trained, etc. For example, any of the processes and control schemes provided for herein can be implemented by way of the computer system 700. The system 700 can include a processor 710, a memory 720, a storage device 730, and an input/output device 740. Each of the components 710, 720, 730, and 740 can be interconnected, for example, using a system bus 750. The processor 710 can be capable of processing instructions for execution within the system 700. The processor 710 can be a single-threaded processor, a multi-threaded processor, or similar device. The processor 710 can be capable of processing instructions stored in the memory 720 or on the storage device 730. The processor 710 may execute one or more of the operations described herein.

The memory 720 can store information within the system 700. In some implementations, the memory 720 can be a computer-readable medium. The memory 720 can, for example, be a volatile memory unit or a non-volatile memory unit. In some implementations, the memory 720 can store information related to various information and/or images that are being compared, among other information.

The storage device 730 can be capable of providing mass storage for the system 700. In some implementations, the storage device 730 can be a non-transitory computer-readable medium. The storage device 730 can include, for example, a hard disk device, an optical disk device, a solid-date drive, a flash drive, magnetic tape, and/or some other large capacity storage device. The storage device 730 may alternatively be a cloud storage device, e.g., a logical storage device including multiple physical storage devices distributed on a network and accessed using a network. In some implementations, the information stored on the memory 720 can also or instead be stored on the storage device 730.

The input/output device 740 can provide input/output operations for the system 700. In some implementations, the input/output device 740 can include one or more of network interface devices (e.g., an Ethernet card), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 740 can include driver devices configured to receive input data and send output data to other input/output devices, e.g., a keyboard, a printer, and/or display devices. In some implementations, mobile computing devices, mobile communication devices, and other devices can be used.

In some implementations, the system 700 can be a microcontroller. A microcontroller is a device that contains multiple elements of a computer system in a single electronics package. For example, the single electronics package could contain the processor 710, the memory 720, the storage device 730, and/or input/output devices 740.

Some non-limiting examples of the above-described embodiments can include the following:
1. An additive manufacturing apparatus, comprising:
   a printing release surface configured to have resin to be printed disposed thereon;
   a drive point configured to move away from the printing release surface while producing an object using the additive manufacturing apparatus;
   a build plate having a main surface that is substantially opposed to the printing release surface, the build plate being configured to move directionally with the drive point;
   a driver configured to move the drive point with respect to the printing release surface; and
   a processor, configured to:
      command the driver to move the drive point towards the printing release surface to an over-plunged position, the over-plunged position being closer to the printing release surface than a target layer position is to the printing release surface;
      command the driver to move the drive point away from the printing release surface, towards the target layer position; and
      command the driver to stop the drive point when it reaches the target layer position.
2. The additive manufacturing apparatus of claim 1,
   wherein the printing release surface is configured to have a high viscosity resin disposed thereon, and
   wherein the processor being configured to command the driver to move the drive point towards the printing release surface to an over-plunged position further comprises the processor being configured to command the driver to move the drive point, as well as the build plate, into a high viscosity resin disposed on the printing release surface.
3. The additive manufacturing apparatus of claim 2, wherein the high viscosity resin has a viscosity value approximately in the range of about 200 centipoise to about 250,000 centipoise.
4. The additive manufacturing apparatus of any of claims 1 to 3, wherein the processor is further configured to:
   calculate a target speed of the build plate to move towards the printing release surface based on a calculated height of the build plate and at least one of: a viscosity of resin used to produce the object, a maximum pressure that can be sustained by the resin used to produce the object, a maximum force that can be sustained by the object, or geometric information about the object;
   determine if the target build plate position has been achieved;
   when the target build plate position has not been achieved, at least one of measure or calculate a build plate height; and
   when the target build plate position has been achieved, maintain the target build plate position.
5. The additive manufacturing apparatus of any of claims 1 to 4, further comprising:
   a housing;
   a vertical rail disposed in the housing;
   a build plate arm coupled to the build plate, the build plate arm coupling the build plate to the vertical rail; and
   a first linear guide disposed on the vertical rail and configured to couple the build plate arm to the vertical rail, the first linear guide being configured to move along the vertical rail to adjust a location of the build plate, the first linear guide being configured to communicate to the processor a measured position.
6. The additive manufacturing apparatus of claim 5, further comprising:
   a pusher arm extending distally at an angle with respect to the vertical rail, the pusher arm having a first end disposed more proximate to the vertical rail and a second end extending further away from the vertical rail than the first end;
   a second linear guide disposed on the vertical rail and configured to couple the pusher arm to the vertical rail, the second linear guide being configured to move along the vertical rail to adjust a location of the build plate in conjunction with the first linear guide such that a driving force applied to at least one of the first and second linear guides is configured to be at least partially transferred to the other of the first and second linear guides; and
   a connector coupling the second end of the pusher arm to the build plate arm.
7. The additive manufacturing apparatus of claim 5 or 6, further comprising:
   one or more force-applying components coupled to at least one of the first or second linear guides to apply a force thereto to move at least one of the first or second linear guides along the vertical rail.
8. The additive manufacturing apparatus of claim 7, wherein the force-applying component is at least one of: (a) a lead screw and lead nut; (b) a stepper motor; or (c) the driver.
9. The additive manufacturing apparatus of any of claims 6 to 8, wherein the connector comprises a pin-in-slot connector.
10. The additive manufacturing apparatus of any of claims 6 to 9, wherein the connector is disposed along a longitudinal axis extending through an approximate center of the build plate, the longitudinal axis being substantially normal to the printing release surface.
11. The additive manufacturing apparatus of any of claims 6 to 9, wherein the connector is disposed away from a longitudinal axis extending through an approximate center of the build plate, further from the vertical rail than the longitudinal axis is from the vertical rail, the longitudinal axis being substantially normal to the printing release surface.
12. The additive manufacturing apparatus of any of claims 6 to 11, wherein a reaction load resulting from a load applied to the build plate and a reaction load applied in the substantially opposite direction by the pusher arm on the build plate are disposed a substantially equal distance away from the first linear guide such that a moment enacted about the first linear guide is substantially zero.
13. The additive manufacturing apparatus of any of claims 6 to 12, further comprising a load cell coupled to the pusher arm and configured to measure a load on the build plate.
14. The additive manufacturing apparatus of any of claims 1 to 13, further comprising a linear encoder coupled to the build plate arm and configured to measure a position of the build plate.
15. The additive manufacturing apparatus of any of claims 1 to 14, wherein printing release surface is transparent.
16. The additive manufacturing apparatus of claim 15, wherein the printing release surface comprises glass.
17. The additive manufacturing apparatus of any of claims 1 to 16, further comprising: a print reservoir in which the printing release surface serves as a base of the reservoir.
18. The additive manufacturing apparatus of any of claims 1 to 17, further comprising:
   a compression component in communication with the build plate such that the compression component is configured to translate a compressive force imparted on the compression component to the build plate to allow the build plate to be aligned in a more parallel manner with respect to the printing release surface.
19. The additive manufacturing apparatus of claim 18, wherein the compression component comprises a spring array.
20. The additive manufacturing apparatus of any of claims 1 to 19, further comprising a controller configured to calculate one or more positions of the build plate.
21. The additive manufacturing apparatus of claim 20, wherein the controller is configured to calculate positions of the build plate based on at least one of one or more measured loads, one or more measured positions of at least one of the drive point or the build plate arm, or calibration data associated with the additive manufacturing apparatus.
22. The additive manufacturing apparatus of claim 20 or 21, wherein the controller is configured to control at least one of a theoretical position of the build plate or a velocity of the build plate.
23. A method of additive manufacturing, comprising:
   commanding a driver to move a drive position towards a printing release surface having resin disposed thereon such that a build plate comes in contact with the resin, the driver commanding the drive position to try and move to an over-plunged position in which the drive position would be located at a position that is closer to the printing release surface than a designated target layer position is to the printing release surface;
   commanding a driver to move the drive position away from the printing release surface, towards the designated target layer position; and
   commanding the driver to stop the drive position at the designated target layer position, a main surface of the build plate being substantially parallel to the printing release surface,
   wherein the drive position controls a position of the build plate.
24. The method of claim 23, wherein the resin is a high viscosity resin having a viscosity value approximately in the range of about 200 centipoise to about 250,000 centipoise.
25. The method of claim 23 or 24, further comprising:
   prior to commanding the drive point to move away from the printing release surface, measuring at least two of a measured load being imparted on the build plate, a measured position of the drive point, or a measured component coupled to the build plate;
   calculating a current build plate position based on at least two of the measured load being imparted on the build plate, the measured position of the drive point, or a measured component coupled to the build plate; and
   determining if the current build plate position is at a designated target layer position,
   wherein if the current build plate position is at the designated target layer position, waiting for the load being imparted on the build plate to reach or decrease below a target load threshold, and after it does, beginning a printing process, and
   wherein if the current build plate position is not at the designated target layer position, commanding the build plate to move towards the printing release surface and continuing the measuring, calculating, and determining actions until the current build plate position is at the designated target layer position.
26. The method of claim 25, wherein beginning a printing process comprises exposing a layer of resin to at least one of a radiation source or a light source to cure the resin.
27. The method of claim 25 or 26, wherein upon completion of the printing process, the method further comprises executing a peel process to remove a printed part from the build plate.
28. The method of any of claims 25 to 27, wherein calculating a current build plate position is performed based on calibration data.
29. The method of any of claims 23 to 28, further comprising:
   after calculating a current build plate position, calculating at least one of a current build plate speed or a target build plate speed; and
   adjusting a speed of the build plate in view of at least one of the calculated current build plate speed or the target build plate speed.
30. The method of claim 29, wherein adjusting a speed of the build plate comprises adjusting a speed of a motor that operates a drive point coupled to the build plate.
31. The method of any of claims 23 to 30, further comprising:
   commanding a drive point to move towards the printing release surface in conjunction with a homing process;
   measuring a load being imparted on the build plate;
   determining if the measured load meets or exceeds a target homing load value;
   wherein if the measured load meets or exceeds the target homing load value, setting the current position of the build plate as zero,
   wherein if the measured load does not meet or exceed the target homing load value, commanding the drive point to move towards the printing release surface and continuing the respective measuring and determining actions until the measured load meets or exceeds the target homing load value.
32. The method of any of claims 23 to 31, further comprising:
   calculating a target speed or a target position of the build plate relative to the printing release surface based on a calculated height of the build plate and at least one of: a viscosity of the resin disposed on the printing release surface, a maximum pressure that can be sustained by the resin disposed on the printing release surface, a maximum force that can be sustained by the resin disposed on the printing release surface, or geometric information about an object to be printed by the additive manufacturing method;
   determining if the designated target build plate position has been achieved;
   if the designated target build plate position has not been achieved, at least one of measuring or calculating a build plate height;
   if the designated target build plate position has been achieved, maintaining the designated target build plate position; and
   exposing at least a portion of the resin to an ultraviolet image.
33. The method of any of claims 23 to 32:
   wherein commanding a build plate to move towards a printing release surface having resin disposed thereon further comprises moving a gantry to a first position along a Z-print axis, the first position being disposed below a target layer height;
   subsequently moving the gantry to a second position along the Z-print axis, the second position being disposed above the first position and being representative of a target layer height of an object being manufactured; and
   curing a layer of the resin while the build plate is disposed at the second position.
34. An additive manufacturing apparatus, comprising:
   a housing;
   a vertical rail disposed in the housing;
   a pusher arm extending distally at an angle with respect to the vertical rail, the pusher arm having a first end disposed more proximate to the vertical rail and a second end extending further away from the vertical rail than the first end;
   a build plate having a substantially flat main surface;
   a printing release surface that is substantially opposed to the main surface of the build plate;
   a build plate arm coupled to the build plate, the build plate arm coupling the build plate to the vertical rail;
   a connector coupling the second end of the pusher arm to the build plate arm; and
   a first linear guide disposed on the vertical rail and configured to couple the build plate arm to the vertical rail.
35. The additive manufacturing apparatus of claim 34, further comprising:
   a second linear guide disposed on the vertical rail and configured to couple the pusher arm to the vertical rail, the second linear guide being configured to move along the vertical rail to adjust a location of the build plate in conjunction with the first linear guide such that a driving force applied to at least one of the first and second linear guides is configured to be at least partially transferred to the other of the first and second linear guides.
36. The additive manufacturing apparatus of claim 34 or 35, further comprising:
   a force-applying component coupled to the pusher guide and configured to apply the driving force to the pusher guide.
37. The additive manufacturing apparatus of claim 36, wherein the force-applying component is at least one of: (a) a lead screw and lead nut; (b) a stepper motor; or (c) a driver.
38. The additive manufacturing apparatus of any of claims 34 to 37, wherein the connector comprises a pin-in-slot connector.
39. The additive manufacturing apparatus of any of claims 34 to 38, wherein the connector is disposed along a longitudinal axis extending through an approximate center of the build plate, the longitudinal axis being substantially normal to the printing release surface.
40. The additive manufacturing apparatus of any of claims 34 to 38, wherein the connector is disposed away from a longitudinal axis extending through an approximate center of the build plate, further from the vertical rail than the longitudinal axis is from the vertical rail, the longitudinal axis being substantially normal to the printing release surface.
41. The additive manufacturing apparatus of any of claims 34 to 40, wherein the printing release surface is transparent.
42. The additive manufacturing apparatus of claim 41, wherein the printing release surface comprises glass.
43. The additive manufacturing apparatus of any of claims 34 to 42, further comprising:
   a print reservoir in which the printing release surface serves as a base of the reservoir.
44. The additive manufacturing apparatus of any of claims 34 to 43, wherein a reaction load resulting from a load applied to the build plate and a reaction load applied in the substantially opposite direction by the pusher arm on the build plate are disposed a substantially equal distance away from the first linear guide such that a moment enacted about the first linear guide is substantially zero.
45. The additive manufacturing apparatus of any of claims 34 to 44, further comprising a load cell coupled to the pusher arm and configured to measure a load on the build plate.
46. The additive manufacturing apparatus of any of claims 34 to 45, further comprising a linear encoder coupled to the build plate arm and configured to measure a position of the build plate.
47. The additive manufacturing apparatus of any of claims 34 to 46, further comprising:
   a release film disposed between the build plate and the printing release surface.
48. The additive manufacturing apparatus of any of claims 34 to 47, further comprising:
   a compression component in communication with the build plate such that the compression component is configured to translate a compressive force imparted on the compression component to the build plate to allow the build plate to be aligned in a more parallel manner with respect to the printing release surface.
49. The additive manufacturing apparatus of claim 48, wherein the compression component comprises a spring array.
50. The additive manufacturing apparatus of any of claims 34 to 49, further comprising a controller configured to calculate one or more positions of the build plate.
51. The additive manufacturing apparatus of claim 50, wherein the controller is configured to calculate positions of the build plate based on at least one of one or more measured loads, one or more determined positions of at least one of the build plate or the build plate arm, or calibration data associated with the additive manufacturing apparatus.
52. The additive manufacturing apparatus of claim 50 or 51, wherein the controller is configured to control at least one of a theoretical position of the build plate or a velocity of the build plate.
53. The additive manufacturing apparatus of any of claims 34 to 52, wherein printing release surface is configured to have a high viscosity resin disposed thereon, the high viscosity resin having a viscosity value approximately in the range of about 200 centipoise to about 250,000 centipoise.
54. The additive manufacturing apparatus of any of claims 34 to 53, further comprising:
   a driver in mechanical communication with the pusher arm such that it is configured to move the build plate with respect to the printing release surface via the pusher arm;
   a processor, configured to:
      command the driver to move the drive point towards the printing release surface to an over-plunged position, the over-plunged position being closer to the printing release surface than a target layer position;
      command the driver to move the drive point away from the printing release surface, towards the target layer position; and
      command the driver to stop the drive point when it reaches the target layer position.
55. The additive manufacturing apparatus of claim 54, wherein the processor is further configured to:
   calculate a target speed of the build plate to move towards the printing release surface based on a height of the build plate and at least one of: a viscosity of resin used to produce an object being manufactured, a maximum pressure that can be sustained by the resin used to produce the object being manufactured, a maximum force that can be sustained by the resin used to produce the object being manufactured, or geometric information about the object being manufactured;
   determine if the target build plate position has been achieved;
   when the target build plate position has not been achieved, at least one of measure or calculate a build plate height; and
   when the target build plate position has been achieved, maintain the target build plate position.

One skilled in the art will appreciate further features and advantages of the present disclosure based on the above-described embodiments. Accordingly, the disclosure is not to be limited by what has been particularly shown and described. Further, a person skilled in the art, in view of the present disclosures, will understand how to implement the disclosed systems and methods provided for herein in conjunction with at least vat polymerization printers, including SLA-style and DLP-style additive manufacturing printers. All publications and references cited herein are expressly incorporated herein by reference in their entireties.

1. An additive manufacturing apparatus, comprising:
a printing release surface configured to have resin to be printed disposed thereon;
a drive point configured to move away from the printing release surface while producing an object using the additive manufacturing apparatus;
a build plate having a main surface that is substantially opposed to the printing release surface, the build plate being configured to move directionally with the drive point;
a driver configured to move the drive point with respect to the printing release surface; and
a processor, configured to:
command the driver to move the drive point towards the printing release surface to an over-plunged position, the over-plunged position being closer to the printing release surface than a target layer position is to the printing release surface;
command the driver to move the drive point away from the printing release surface, towards the target layer position; and
command the driver to stop the drive point when it reaches the target layer position.

2. The additive manufacturing apparatus of claim 1,
wherein the printing release surface is configured to have a high viscosity resin disposed thereon, and
wherein the processor being configured to command the driver to move the drive point towards the printing release surface to an over-plunged position further comprises the processor being configured to command the driver to move the drive point, as well as the build plate, into a high viscosity resin disposed on the printing release surface.

3. The additive manufacturing apparatus of claim 2, wherein the high viscosity resin has a viscosity value approximately in the range of about 200 centipoise to about 250,000 centipoise.

4. The additive manufacturing apparatus of claim 1, wherein the processor is further configured to:
calculate a target speed of the build plate to move towards the printing release surface based on a calculated height of the build plate and at least one of: a viscosity of resin used to produce the object, a maximum pressure that can be sustained by the resin used to produce the object, a maximum force that can be sustained by the object, or geometric information about the object;
determine if the target build plate position has been achieved;
when the target build plate position has not been achieved, at least one of measure or calculate a build plate height; and
when the target build plate position has been achieved, maintain the target build plate position.

5. The additive manufacturing apparatus of claim 1, further comprising:
a housing;
a vertical rail disposed in the housing;
a build plate arm coupled to the build plate, the build plate arm coupling the build plate to the vertical rail; and
a first linear guide disposed on the vertical rail and configured to couple the build plate arm to the vertical rail, the first linear guide being configured to move along the vertical rail to adjust a location of the build plate, the first linear guide being configured to communicate to the processor a measured position.

6. The additive manufacturing apparatus of claim 5, further comprising:
a pusher arm extending distally at an angle with respect to the vertical rail, the pusher arm having a first end disposed more proximate to the vertical rail and a second end extending further away from the vertical rail than the first end;
a second linear guide disposed on the vertical rail and configured to couple the pusher arm to the vertical rail, the second linear guide being configured to move along the vertical rail to adjust a location of the build plate in conjunction with the first linear guide such that a driving force applied to at least one of the first and second linear guides is configured to be at least partially transferred to the other of the first and second linear guides; and
a connector coupling the second end of the pusher arm to the build plate arm.

7. The additive manufacturing apparatus of claim 6, further comprising a load cell coupled to the pusher arm and configured to measure a load on the build plate.

8. A method of additive manufacturing, comprising:
commanding a driver to move a drive position towards a printing release surface having resin disposed thereon such that a build plate comes in contact with the resin, the driver commanding the drive position to try and move to an over-plunged position in which the drive position would be located at a position that is closer to the printing release surface than a designated target layer position is to the printing release surface;
commanding a driver to move the drive position away from the printing release surface, towards the designated target layer position; and
commanding the driver to stop the drive position at the designated target layer position, a main surface of the build plate being substantially parallel to the printing release surface,
wherein the drive position controls a position of the build plate.

9. The method of claim 8, wherein the resin is a high viscosity resin having a viscosity value approximately in the range of about 200 centipoise to about 250,000 centipoise.

10. The method of claim 8, further comprising:
prior to commanding the drive point to move away from the printing release surface, measuring at least two of a measured load being imparted on the build plate, a measured position of the drive point, or a measured component coupled to the build plate;
calculating a current build plate position based on at least two of the measured load being imparted on the build plate, the measured position of the drive point, or a measured component coupled to the build plate; and
determining if the current build plate position is at a designated target layer position,
wherein if the current build plate position is at the designated target layer position, waiting for the load being imparted on the build plate to reach or decrease below a target load threshold, and after it does, beginning a printing process, and
wherein if the current build plate position is not at the designated target layer position, commanding the build plate to move towards the printing release surface and continuing the measuring, calculating, and determining actions until the current build plate position is at the designated target layer position.

11. The method of claim 8, further comprising:
after calculating a current build plate position, calculating at least one of a current build plate speed or a target build plate speed; and
adjusting a speed of the build plate in view of at least one of the calculated current build plate speed or the target build plate speed.

12. The method of claim 11, wherein adjusting a speed of the build plate comprises adjusting a speed of a motor that operates a drive point coupled to the build plate.

13. The method of claim 8, further comprising:
commanding a drive point to move towards the printing release surface in conjunction with a homing process;
measuring a load being imparted on the build plate;
determining if the measured load meets or exceeds a target homing load value;
wherein if the measured load meets or exceeds the target homing load value, setting the current position of the build plate as zero,
wherein if the measured load does not meet or exceed the target homing load value, commanding the drive point to move towards the printing release surface and continuing the respective measuring and determining actions until the measured load meets or exceeds the target homing load value.

14. The method of claim 8, further comprising:
calculating a target speed or a target position of the build plate relative to the printing release surface based on a calculated height of the build plate and at least one of: a viscosity of the resin disposed on the printing release surface, a maximum pressure that can be sustained by the resin disposed on the printing release surface, a maximum force that can be sustained by the resin disposed on the printing release surface, or geometric information about an object to be printed by the additive manufacturing method;
determining if the designated target build plate position has been achieved;
if the designated target build plate position has not been achieved, at least one of measuring or calculating a build plate height;
if the designated target build plate position has been achieved, maintaining the designated target build plate position; and
exposing at least a portion of the resin to an ultraviolet image.

15. The method of claim 8:
wherein commanding a build plate to move towards a printing release surface having resin disposed thereon further comprises moving a gantry to a first position along a Z-print axis, the first position being disposed below a target layer height;
subsequently moving the gantry to a second position along the Z-print axis, the second position being disposed above the first position and being representative of a target layer height of an object being manufactured; and
curing a layer of the resin while the build plate is disposed at the second position.

16-23. (canceled)
